(19) United States
(12) Patent Application Publication
(10) Pub. No.: US 2014/0351096 A1
(43) Pub. Date: Nov. 27, 2014

(54) TECHNIQUES FOR FACILITATING ACQUISITION AND EXCHANGE OF EBOOK AND OTHER DIGITAL CONTENT VIA A COMPUTER NETWORK

(71) Applicants: Katherine Laurel Radziwon, Lake Oswego, OR (US); Kevin Robert Merritt, Brooklyn, NY (US)

(72) Inventors: Katherine Laurel Radziwon, Lake Oswego, OR (US); Kevin Robert Merritt, Brooklyn, NY (US)

(21) Appl. No.: 14/286,978

(22) Filed: May 23, 2014

Related U.S. Application Data
(60) Provisional application No. 61/826,508, filed on May 23, 2013.

(51) Int. Cl. G06Q 30/06; G06Q 20/12

(52) U.S. Cl. CPC G06Q 30/0645; G06Q 20/1235
USPC 705/26.81

(57) ABSTRACT

Various aspects are described herein for facilitating acquisition, exchange and leasing of digital media products via computer networks. Various Digital Media Exchange and Licensing techniques are described herein for facilitating and enabling monetization of a leased digital media product during “idle” times of the lease term such as, for example, when the leased digital media product is no longer being accessed and/or utilized or when the digital media product is no longer needed or desired by the renter or lessor. In some embodiments, revenue generated from such monetization may be shared with the digital media product content creators and/or content providers.

### RELATED APPLICATION DATA

The present application claims benefit, pursuant to the provisions of 35 U.S.C. §119, of U.S. Provisional Application Ser. No. 61/826,508 (Attorney Docket No. IFLIPP001P), titled “TECHNIQUES FOR FACILITATING ACQUISITION AND EXCHANGE OF EBOOK AND OTHER DIGITAL CONTENT VIA A COMPUTER NETWORK”, naming Radziwon et al. as inventors, and filed 23 May 2013, the entirety of which is incorporated herein by reference for all purposes.

### BACKGROUND

The present disclosure relates to techniques for facilitating monetization of leased products and/or services, particularly those relating to leased digital media products.

Most of today's currently existing leasing and rental business models are set up to enable a rental or leasing entity (Lessor) to rent/lease a given product or service to a given customer (Lessee) for a specified duration of time. During the time that the Lessee leases the product/service (herein referred to as the “lease term”), the Lessee is typically provided with a significant degree of access and control over the leased product/service, thereby resulting in the leased product/service being unavailable to be leased by other customers during the lease term. Moreover, if during portions of the lease term, the leased product/service is not used or utilized by the Lessee, there typically are no established mechanisms which allow either the Lessor or the Lessee to further monetize the leased product/service during such times.

### BRIEF DESCRIPTION OF THE DRAWINGS

FIG. 1 illustrates a simplified block diagram of a specific example embodiment of a Digital Media Exchange and Licensing (DME/L) System.

FIG. 2 shows a specific example embodiment of a network diagram illustrating various aspects of a DME/L System.

FIG. 3 shows a diagrammatic representation of machine in the exemplary form of a client (or end user) computer system.

FIG. 4 is a simplified block diagram of an exemplary client system 400 in accordance with a specific embodiment.

FIG. 5 illustrates an example embodiment of a server system 580 which may be used for implementing various aspects/features described herein.

FIG. 6 illustrates an example of a functional block diagram of a DME/L Server System in accordance with a specific embodiment.

FIGS. 7-9 illustrate various example embodiments of different DME/L procedures and/or procedural flows which may be used for facilitating activities relating to one or more of the Digital Media Exchange/Lease aspects disclosed herein.

FIG. 10 shows an example of a DME/L State Diagram in accordance with a specific embodiment.

FIGS. 11-28 illustrate example screenshots of various GUIs which may be used for facilitating activities relating to one or more of the Digital Content Exchange aspects disclosed herein.

### DETAILED DESCRIPTION OF EXAMPLE EMBODIMENTS

### Overview

Various aspects described or referenced herein are directed to different methods, systems, and computer program products for facilitating acquisition, exchange and leasing of digital media products via computer networks. One or more aspects disclosed herein are directed to different techniques for facilitating and enabling monetization of a leased digital media product during “idle” times of the lease term such as, for example, when the leased digital media product is no longer being accessed and/or utilized or when the digital media product is no longer needed or desired by the Lessor.

One aspect disclosed herein is directed to different methods, systems, and computer program products for facilitating electronic commerce via a computer network. In at least one embodiment, various method(s), system(s) and/or computer program product(s) may be operable to cause at least one processor to execute a plurality of instructions for: providing a first user with electronic access to a first digital media library, the first digital media library including a first set of digital media products; receiving a first rental request to lease or rent a first digital media product (“first DMP”) to a first user, the first DMP including a first portion of media content; determining a first lease term associated with the first DMP; initiating, in response to the first rental request, a first digital media product (DMP) lease purchase transaction for leasing the first DMP to the first user for a first rental period as defined by the first lease term; receiving a first lease fee payment in connection with the first DMP lease purchase transaction; generating access rights for enabling user access to access the first DMP and its media content during the first rental period; granting, in response to completing the first DMP lease purchase transaction, the first user with access rights for enabling the first user to access the first DMP and its media content during the first rental period; receiving a first Flip request to initiate a first Flip transaction to Flip the first DMP into a Flip Pool Library; if it is determined that the first rental period has not expired, initiating, in response to the first Flip request, the first Flip transaction to Flip the first DMP into the Flip Pool Library; rescinding, in response to completing the first Flip transaction, the first user's access rights to access the first DMP and its media content during the first rental period; and; enabling, in response to completing the first Flip transaction, other users to lease the first DMP from the Flip Pool Library before an expiration of the first rental period.

Additional method(s), system(s) and/or computer program product(s) may be further operable to cause at least one processor to execute additional instructions for granting, in response to completing the first Flip transaction, the first user a reward or bonus. In some embodiments, the reward or bonus may be a specified number of Flip Days which may be used to extend rental periods of other digital media products rented to the user.

Additional method(s), system(s) and/or computer program product(s) may be further operable to cause at least one processor to execute additional instructions for allocating portion of the first lease fee payment to a content creator or content provider of the first DMP.

Additional method(s), system(s) and/or computer program product(s) may be further operable to cause at least one processor to execute additional instructions for: dynamically determining a first amount of Flip Day(s) to be awarded to the first user upon completion of the first Flip transaction; and; granting the first user with the first amount of Flip Day(s) in response to completing the first Flip transaction.

Additional method(s), system(s) and/or computer program product(s) may be further operable to cause at least one processor to execute additional instructions for: determining a current amount of remaining rental time of the first rental period associated with the first DMP; and; dynamically determining, using the current amount of remaining rental time, a Flipped rental fee for renting or leasing the first DMP from the Flip Pool Library.

Additional method(s), system(s) and/or computer program product(s) may be further operable to cause at least one processor to execute additional instructions for: receiving a second rental request to lease or rent the first DMP from the Flip Pool Library to a second user; initiating, in response to the second rental request, a Flipped DMP leasing transaction for leasing the first DMP from the Flip Pool Library to the second user; receiving a Flipped rental fee payment in connection with the Flipped DMP leasing transaction; granting, in response to completing the Flipped DMP leasing transaction, the second user with access rights for enabling the second user to access the first DMP and its media content while the first rental period has not yet expired; and; allocating portion of the Flipped rental fee payment to a content creator of the first DMP.

Additional method(s), system(s) and/or computer program product(s) may be further operable to cause at least one processor to execute additional instructions for: receiving a second rental request to lease or rent the first DMP from the Flip Pool Library to a second user; determining an amount of remaining rental time of the first rental period associated with the first DMP; dynamically determining, using the amount of remaining rental time, a Flipped rental fee for renting or leasing the first DMP from the Flip Pool Library; initiating, in response to the second rental request, a Flipped DMP leasing transaction for leasing the first DMP from the Flip Pool Library to the second user; receiving the Flipped rental fee payment in connection with the Flipped DMP leasing transaction; granting, in response to completing the Flipped DMP leasing transaction, the second user with access rights for enabling the second user to access the first DMP and its media content while the first rental period has not yet expired; and; allocating portion of the Flipped rental fee payment to a content creator of the first DMP.

Additional method(s), system(s) and/or computer program product(s) may be further operable to cause at least one processor to execute additional instructions for: receiving a second rental request to lease or rent the first DMP from the Flip Pool Library to a second user; initiating, in response to the second rental request, a Flipped DMP leasing transaction for leasing the first DMP from the Flip Pool Library to the second user; providing an opportunity for the second user to extend the rental period associated with first DMP; extending the rental period associated with first DMP by a specified amount of time in response to received input from the second user; receiving a Flipped rental fee payment in connection with the Flipped DMP leasing transaction; granting, in response to completing the Flipped DMP leasing transaction, the second user with access rights for enabling the second user to access the first DMP and its media content while the extended rental period has not yet expired.

Additional method(s), system(s) and/or computer program product(s) may be further operable to cause at least one processor to execute additional instructions for: receiving a second rental request to lease or rent the first DMP from the Flip Pool Library to a second user; initiating, in response to the second rental request, a Flipped DMP leasing transaction for leasing the first DMP from the Flip Pool Library to the second user; granting, in response to completing the Flipped DMP leasing transaction, the second user with access rights for enabling the second user to access the first DMP and its media content while the first rental period has not yet expired; and; preventing, in response to completing the Flipped DMP leasing transaction, other users from renting or leasing the first DMP from the Flip Pool Library while the second user has access rights for enabling the second user to access the first DMP and its media content.

Various objects, features and advantages of the various aspects described or referenced herein will become apparent from the following descriptions of its example embodiments, which descriptions should be taken in conjunction with the accompanying drawings.

### Specific Example Embodiments

Various techniques will now be described in detail with reference to a few example embodiments thereof as illustrated in the accompanying drawings. In the following description, numerous specific details are set forth in order to provide a thorough understanding of one or more aspects and/or features described or reference herein. It will be apparent, however, to one skilled in the art, that one or more aspects and/or features described or reference herein may be practiced without some or all of these specific details. In other instances, well known process steps and/or structures have not been described in detail in order to not obscure some of the aspects and/or features described or reference herein.

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

Techniques and mechanisms described or reference herein will sometimes be described in singular form for clarity. However, it should be noted that particular embodiments include multiple iterations of a technique or multiple instantiations of a mechanism unless noted otherwise.

### The Digital Media Product “Flip” Transaction

As described above, various aspects disclosed herein are directed to different techniques for facilitating acquisition, exchange and leasing of digital media products via computer networks. One or more of these aspects are directed to different techniques for facilitating and enabling monetization of a leased digital media product during “idle” times of the lease term (e.g., when the leased digital media product is no longer being accessed and/or utilized, or when the digital media product is no longer needed or desired by the current Lessor) by providing functionality for enabling the leased digital media product to be “Flipped” into a pool of previously leased digital media products, and for enabling subsequent users or customers to pay a fee for acquiring rights to access/utilize the Flipped digital media product during the remaining lease term of that digital media product's lease.

As described herein, the term “Flip” may be defined as a user action of terminating an existing n day (e.g., 7 day) Digital Media Product rental and offering up the remaining rental days to a user pool for a discounted rental rate. The “Flip” provides value to both the user who “Flips” (“Flipor”) (in the form of a type of credit to be redeemed later) and to the acquiring user (“Flipee”) (in the form of a discounted/pro-rated rental rate for the remaining days on the content).

The Flip Transaction is but one aspect of the various Digital Media Exchange and Licensing techniques described herein, and serves as a relatively easy and economical solution for the acquisition and exchange of leased Digital Media Products.

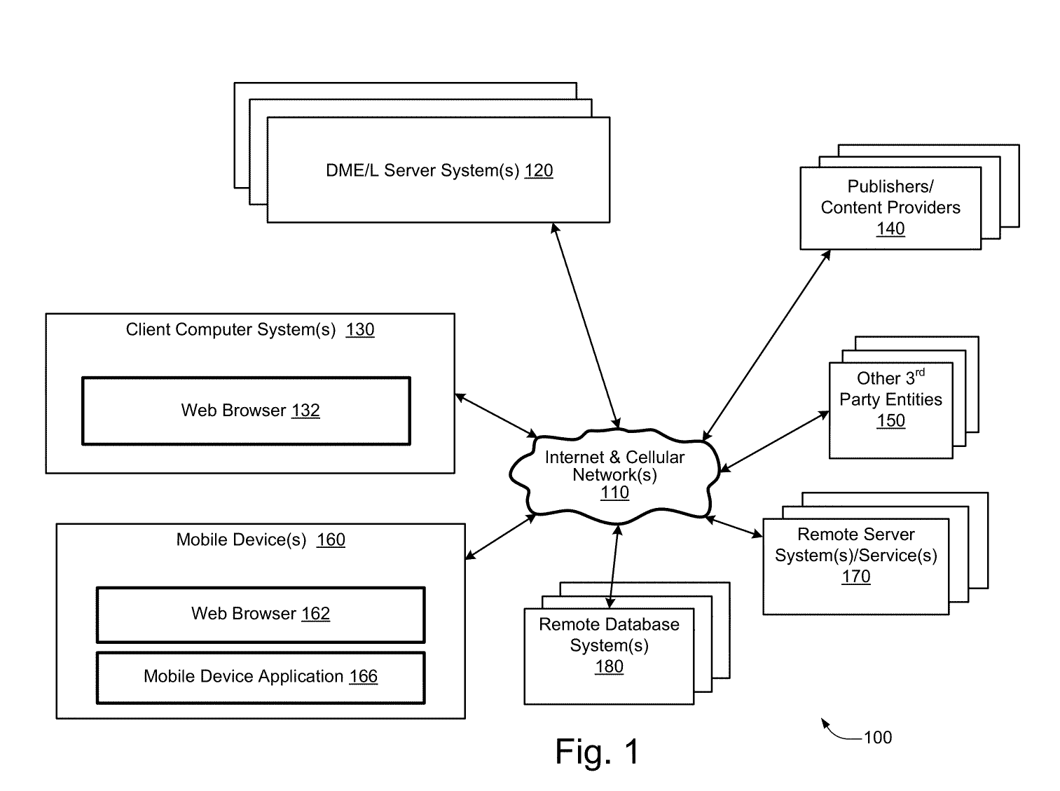

FIG. 1 illustrates a simplified block diagram of a specific example embodiment of a Digital Media Exchange and Licensing (DME/L) System 100 which may be implemented via a computerized data network. As described in greater detail herein, different embodiments of Digital Media Exchange and Licensing Systems may be configured, designed, and/or operable to provide various different types of operations, functionalities, and/or features generally relating to Digital Media Exchange and Licensing technology. Further, as described in greater detail herein, many of the various operations, functionalities, and/or features of the Digital Media Exchange and Licensing System(s) disclosed herein may provide may enable or provide different types of advantages and/or benefits to different entities interacting with the Digital Media Exchange and Licensing System(s).

For example, as applied to the digital electronic book (e-book) industry, the Digital Media Exchange and Licensing techniques described herein provide new opportunities for users to access and read e-books, share them with others, and get rewarded for doing it. The DME/L System may leverage social networking and e-commerce to deliver platforms and experiences where book lovers may explore, purchase, rent, and share books within a secure community The DME/L System allows users to rent and purchase e-books, while interacting within a network of friends.

In one embodiment, the DME/L System may be based on a flat rate microtransaction model. For example, for $2 a week users may read an e-book. If they have not returned the book after seven days, the system may auto renew the title to the user for another $2 for a week. This process may continue up to the maximum retail price of the book, set by the publisher. If the user chooses to Flip their e-book back into the system (e.g., into a “Flip Pool” Library) before the rental period has expired, they may do so at no cost. Any remaining days may stay with the e-book in the “Flip Pool Library” and the user may collect “Flip Days” in a day bank. The user may pay a reduced rental fee to check out other e-books from the Flip Pool Library, and may also use their accumulated Flip Days to extend the lease term (or rental time) of the checked-out e-book. When the lease term of the rented e-book expires, the user may go back to the rental model if they do not return (e.g., check-in) the e-book back to the system. Users may also earn extra days through social interactions including, but not limited to, posting to social networks, rating, reviewing, and recommending books, sharing notes or quotes, etc. This creates a game within the application that allows for users to accrue days and use them as opportunity to read more books.

### DME/L System Overview

In at least one embodiment, the DME/L System may be adapted for use in the B2C online marketplace with full-feature e-commerce and social networking components (sharing/sending with friends, posting achievements, etc.). End users access thru mobile platforms or a website with a user account to conduct searches, interact with others, and complete transactions.

According to different embodiments, the Digital Media Exchange and Licensing System 100 may include a plurality of different types of components, devices, modules, processes, systems, etc., which, for example, may be implemented and/or instantiated via the use of hardware and/or combinations of hardware and software. For example, as illustrated in the example embodiment of FIG. 1, the Digital Media Exchange and Licensing System may include one or more of the following types of systems, components, devices, processes, etc. (or combinations thereof):
Digital Media Exchange and Licensing (DME/L) Server System(s) 120—In at least one embodiment, the DME/L Server System(s) may be operable to perform and/or implement various types of functions, operations, actions, and/or other features such as those described or referenced herein.
Publisher/Content Provider System component(s) 140
Client Computer System (s) 130
3^{rd} Party System(s) 150
Internet & Cellular Network(s) 110
Remote Database System(s) 180
Remote Server System(s)/Service(s) 170, which, for example, may include, but are not limited to, one or more of the following (or combinations thereof):
   Content provider servers/services
   Media Streaming servers/services
   Database storage/access/query servers/services
   Financial transaction servers/services
   Payment gateway servers/services
   Electronic commerce servers/services
   Event management/scheduling servers/services
   Etc.
Mobile Device(s) 160—In at least one embodiment, the Mobile Device(s) may be operable to perform and/or implement various types of functions, operations, actions, and/or other features such as those described or referenced herein.
etc.

### Example Front-End Operations of the DME/L Server System

According to different embodiments, various types of processes, actions, operations, etc., may be initiated and/or performed by the DME/L Server System for enabling users to interact with the DME/L Server System and perform various tasks and activities as described herein. In at least one embodiment, the DME/L Server System may include a Front-End System which may be configured or designed to facilitate, initiate, and/or handle interactions with end users. By way of example, an example walk-through scenario is described below to help illustrate the various types of processes, actions, operations, etc., which may be initiated and/or performed by the Front-End of the DME/L Server System:
User may interact with the DME/L System on the Sign In screen. User may sign in with a Facebook log in, or user may create a unique/new registration account. “What is the DME/L System?” and “How does the DME/L System Work”, videos may be accessed.
User may be directed to “Invite Your Friends” screen. Here user may invite contacts to join the DME/L System and users Network. User earns “Flip Days” (credits used to rent books) when invited friends join the DME/L System. User is not required to invite friends and may proceed without inviting anyone.
User visits “What are you Interests?” screen. Here user may select book categories of interest. User preferences used to create a unique user bookcase. After selecting preferences, user proceeds to the “Home” screen, a reading room with a bookcase populated with their interest
In the Home screen, user has access a bookshelf populated with one or more of the collections they selected in the interests screen. From here a user may navigate to the different collections to begin browsing books. A pull-out menu to the left gives access to one or more of the DME/L System collections. Also allows user to search for a book by title, author, or genre. User has access to a pull-down menu from the top that may access one or more account information and settings. In this particular example scenario, it is assumed that the user selects “Romance” collection from the Home screen to see what's available.
In the Romance collection user may sort collection by Best Selling, Award Winners, Staff Recommendations, Top Rated, etc. The user may also search for a specific author, title, ISBN, etc. At this point, user is ready to take a closer look at one specific book and selects “The Witch's Daughter”. This page also has a ticker of recently Flipped books and a newsfeed of friends' interactions with the DME/L System.
On the detail screen the user may acquire “The Witch's Daughter”, read reviews, see which friends have read this book etc. They are given the option to purchase the title, rent the title, view available Flips, or share the title to a social network. At this point the user decides to rent this book.
User may be directed to a payment screen that allows them to add a credit card, confirm the rental, or go back. Transaction takes place between user and the DME/L System giving eBook access to user.
At this point the user is given the option to read the book or go back and browse more books. The user chooses to read the book and the book is downloaded to their library and the e-book opens.
After rental, or purchase, user may have access to the book through the DME/L System reader. Reader page has an option that allows the left portion of the screen to show Author Commentary, and notes written by you, and others in the DME/L System and your network. This feature may be turned off, allowing the whole screen for reading.
When finished reading session, user comes back to Home screen and may explore other parts of the app. They may also browse the books in their library and decide to keep or Flip books.
In the DME/L System the user may add other users to a main account. The admin may set up the account and provide credit card information. From a drop down menu a user may switch users and be directed to a wizard screen that allows you to choose another user and set up a separate library and friend network, etc. At least one account may have up to 10 users.

### Example Back-End Operations of the DME/L Server System

In at least one embodiment, the DME/L Server System may include a Back-End System which may be configured or designed to facilitate, initiate, and/or handle internal transactions, and interactions remote entities/systems such as, for example, publisher systems, content providers, financial transaction servers, remote databases, etc. Examples of the various types of processes, actions, operations, etc., which may be initiated and/or performed by the Back-End of the DME/L Server System may include, but are not limited to, one or more of the following (or combinations thereof):
Polling content providers/publishers for updated catalog info.
Updating of the DME/L System's Media Library (e.g., for rentals, purchases, Flips, etc.).
Downloading digital media (e-book) from CP/PUB and storing on local server.
Providing access of digital media to selected users.
Handling of financial payment transactions.
Tracking licensing information (e.g., remaining rental time window) for downloaded
digital media.
Tracking of ownership of digital media (e.g., as rented by user A, Flipped by user A (Flipor) into Flip Pool Library, Checked-Out by user B (Flipee), etc.).

According to different embodiments, at least some DME/L System(s) may be configured, designed, and/or operable to provide a number of different features, advantages and/or benefits, such as, for example, one or more of the following (or combinations thereof):
New eBook rental distribution model.
Creates connection between reading and social networking.
Rich experience in visually appealing interface.
Rewards social interactions.
Creates a game with books and reading.
Unique Flipping models creates a secondhand marketplace for e-books.
Data analytics allows publishers direct feedback on the user behavior.
Potential to create “collections” much like playlists for books.
Possible integration into education, magazines, periodicals.
A technology stack (e.g., language agnostic) suitable for support of a high-volume merchant services web business (e.g. Python, Java, .NET).
A technology stack that minimizes the amount of new “from scratch” development—readymade rapid development framework solutions (e.g. Hibernate, Django, Turbogears, Spring, Seam, RoR . . . etc.).
A technology stack that includes a full featured DRM for appropriate levels of access control to site content.
A technology stack and development environment that is optimized for quick development, while at the same time allows for a clear path to scale.
A technology stack that doesn't require large upfront investment in infrastructure and allows for pay as you go development in a cloud environment.
A technology stack that utilizes best practices around object oriented programming, MVC pattern, API based apps for multiple platforms.

In at least some embodiments, the DME/L System may be configured or designed to address various problems/opportunities such as, for example, one or more of the following (or combinations thereof):
Buying books at a book store is expensive and time consuming
The introduction of e-books has made the purchase experience easier, but raises valid consumer concerns about security, returns, compatibility among different e-readers, and availability of titles.
At the intersection of social networking and e-commerce, we see a profound window to create a new online environment where book lovers can purchase, read, and SHARE books within a community of friends, family, and acquaintances.
This sharing capability presents an opportunity to create ad-hoc networks and communities within a closed system where titles can be traded (or “Flipped”) for a fee.

According to different embodiments, the DME/L System 100 may include a plurality of different types of components, devices, modules, processes, systems, etc., which, for example, may be implemented and/or instantiated via the use of hardware and/or combinations of hardware and software. For example, as illustrated in the example embodiment of FIG. 1, the DME/L System may include one or more types of systems, components, devices, processes, etc. (or combinations thereof) described and/or referenced herein.

According to different embodiments, various different types of encryption/decryption techniques may be used to facilitate secure communications between devices in DME/L System(s) and/or DME/L Network(s). Examples of the various types of security techniques which may be used may include, but are not limited to, one or more of the following (or combinations thereof): random number generators, SHA-1 (Secured Hashing Algorithm), MD2, MD5, DES (Digital Encryption Standard), 3DES (Triple DES), RC4 (Rivest Cipher), ARC4 (related to RC4), TKIP (Temporal Key Integrity Protocol, uses RC4), AES (Advanced Encryption Standard), RSA, DSA, DH, NTRU, and ECC (elliptic curve cryptography), PKA (Private Key Authentication), Device-Unique Secret Key and other cryptographic key data, SSL, etc. Other security features contemplated may include use of well known hardware-based and/or software-based security components, and/or any other known or yet to be devised security and/or hardware and encryption/decryption processes implemented in hardware and/or software.

It will be appreciated that the DME/L System of FIG. 1 is but one example from a wide range of DME/L System embodiments which may be implemented. Other embodiments of the DME/L System (not shown) may include additional, fewer and/or different components/features that those illustrated in the example DME/L System embodiment of FIG. 1.

Generally, the DME/L techniques described herein may be implemented in hardware and/or hardware+software. For example, they can be implemented in an operating system kernel, in a separate user process, in a library package bound into network applications, on a specially constructed machine, or on a network interface card. In a specific embodiment, various aspects described herein may be implemented in software such as an operating system or in an application running on an operating system.

Hardware and/or software+hardware hybrid embodiments of the DME/L techniques described herein may be implemented on a general-purpose programmable machine selectively activated or reconfigured by a computer program stored in memory. Such programmable machine may include, for example, mobile or handheld computing systems, PDA, smart phones, note-book computers, tablets, netbooks, desktop computing systems, server systems, cloud computing systems, network devices, etc.

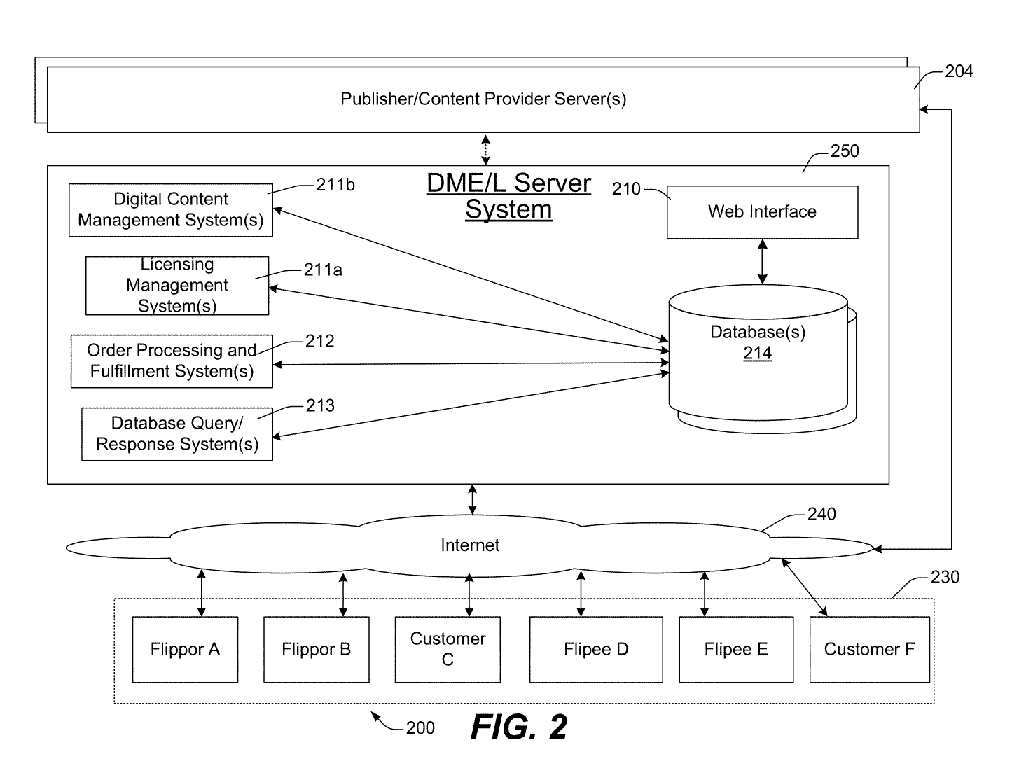

FIG. 2 shows a specific example embodiment of a network diagram illustrating various aspects of a DME/L System 200, which may be utilized for implementing various aspects, described herein. In at least one embodiment, the interaction diagram of FIG. 2 illustrates the technical aspects of how the DME/L System initiates and/or performs a variety of different types of DME/L operations and/or activities such as those described herein.

According to specific embodiments, the DME/L System may be accessible to various entities such as, for example: individual persons, users/customers, purchasers, corporate or business entities, system administrators, online content providers, online publishers, merchants, copyright holders, etc.

In at least one embodiment, the DME/L System may include a plurality of components operable to perform and/or implement various types of functions, operations, actions, and/or other features such as, for example, one or more of the following (or combinations thereof):
DME/L Server System (e.g. 250). In at least one embodiment, the DME/L Server System may include, but is not limited to, various types of functions and/or features such as, for example, one or more of those described and/or referenced herein. In at least one embodiment, the DME/L Server System may include, but are not limited to, one or more of the following components/sub-systems (or combinations thereof):
Digital Media Product Management System(s)
Licensing Management System(s)
Order Processing and Fulfillment System(s)
Database Query/Response System(s)

In at least one embodiment, the DME/L System may be configured or designed to facilitate and manage the purchase, rental, and/or exchange of various types of Digital Media Product/media such as, for example, one or more of the following (or combinations thereof):
text-based Digital Media Product such as, for example, ePubs, eBooks, digital magazines, digital magazine articles, digital newspapers, digital newspaper articles, etc.
digital music content such as, for example, songs, albums, playlists, etc.
digital video content such as, for example, movies, TV shows, sporting events, cartoons, educational videos, adult content; etc.
digital game content which, for example, may include executable PC/MAC based games, player station games (e.g., XBOX, PlayStation, Wii, etc.)
audiobooks
digital images
and/or any other type of Digital Media Product which may be purchased, rented, licensed, etc.

In at least one embodiment, a GUI may be displayed to the purchaser to facilitate the online purchase of the item of Digital Media Product. In one embodiment, the GUI may be implemented in the form of a dynamic overlay layer which enables the purchaser to complete the purchase or rental of desired items of Digital Media Product without causing the user's browser application to navigate away from the underlying web page. In at least one embodiment, a User Web Interface (e.g., 22, FIG. 2) may provide functionality for dynamically generating at least a portion of the overlay layer GUI.

As illustrated in the example embodiment of FIG. 2, DME/L System may include one or more databases (e.g. 240, FIG. 2), which, for example, may be populated with information relating to:
Digital Media Product available for purchase, rental, available for Flipped acquisition, etc.
customer profile information
customer transaction history
customer credit/award history
financial transactions
Digital Media Product licensing/rental information
order transaction information
etc.

In at least one embodiment, one or more of the databases may be queried via the use of various types of programming languages and/or protocols such as, for example, one or more of the following (or combinations thereof):
HTML
XML
MySQL
Perl
Ajax
JavaScript
Etc.

In at least one embodiment, a purchaser may initiate a DME/L session via the Internet (e.g., via 240, FIG. 2) to cause the DME/L System to search out and/or find the best deals for renting or accessing multiple different items of Digital Media Product, according to user-specified purchasing criteria.

In at least one embodiment, the DME/L System may be operable to populate and/or access information at Database(s) 214, and utilize such information in order to identify and/or determine available Digital Media Product information. Examples of such database information may include, but are not limited to, one or more of the following (or combinations thereof):
Negative filter criteria;
Pricing criteria;
Author criteria (e.g., show only available Digital Media Product associated with an a selected author which has been identified, for example, based upon the user's browsing activities and/or the content being displayed or presented to the user);
Brand-related criteria such as, for example, branding information related to (or associated with) one or more of the following (or combinations thereof):
   TV Shows
   Song;
   Band;
   Team;
   Celebrity;
   Album;
   Sporting event
   Movie title
   Sports team,
   Venue;
   Gaming platforms
   Companies
   Trademarks
   Corporate Identities
   Content owners
   Publisher
   Author
   Distributor
Digital Media Product criteria
Etc.

In at least one embodiment, after a user has completed the Digital Media Product selection process, the DME/L System may present the purchaser/user with a GUI displaying their user-selected items in a cart for review. To complete the transaction, the user may provide appropriate payment information via the GUI.

In at least one embodiment, after the user has completed the checkout process, the Order Processing and Fulfillment System (e.g., 212, FIG. 2) may record details of the order in one or more databases, and may automatically forward the order information to an appropriate system/sub-system/component for processing and order fulfillment. Additionally, in at least one embodiment, the DME/L System may be operable to automatically track the progress of the order such as, for example, order confirmation, order fulfillment, user access and ownership rights, Flipping transactions, bonuses/awards, refunds, etc.

For example, in at least one embodiment, the DME/L System functionality may be operable to perform and/or implement various types of functions, operations, actions, and/or other features such as, for example, one or more of the following (or combinations thereof):
Monitor user behaviors and activities;
Identify brand-related information associated with user-accessible content that the user is accessing; has requested access to; and/or has interest in;
Identify available Digital Media Product based on specified criteria;
Facilitate exchange of temporarily licensed (or temporarily owned/rented) Digital Media Product with other user;
Manage and track revenue sharing;
Manage reporting;
Transact online ordering and purchasing;
Transact Database queries/responses
Acquire and manage Digital Media Product and associated licenses;
Manage customer subscription services;
Provide query disambiguation;
Provide input correction/suggestion functionality such as, for example, normalization of brand name, brand identity and/or other searchable criteria amongst misspelled and/or other spelling variations;
Facilitate order management and access to Digital Media Product;
Etc.

According to specific embodiments, multiple instances or threads of the DME/L System functionality may be concurrently implemented and/or initiated via the use of one or more processors and/or other combinations of hardware and/or hardware and software. For example, in at least some embodiments, various aspects, features, and/or functionalities of the DME/L System mechanism(s) may be performed, implemented and/or initiated by one or more systems, components, systems, devices, procedures, processes, etc. (or combinations thereof) described and/or referenced herein.

According to different embodiments, one or more different threads or instances of the DME/L System functionality may be initiated in response to detection of one or more conditions or events satisfying one or more different types of minimum threshold criteria for triggering initiation of at least one instance of the DME/L System functionality. Various examples of conditions or events which may trigger initiation and/or implementation of one or more different threads or instances of the DME/L System functionality may include, but are not limited to, one or more types of conditions and/or events described or referenced herein.

According to different embodiments, one or more different threads or instances of the DME/L System functionality may be initiated in response to detection of one or more conditions or events satisfying one or more different types of minimum threshold criteria for triggering initiation of at least one instance of the DME/L System functionality. Various examples of conditions or events which may trigger initiation and/or implementation of one or more different threads or instances of the DME/L System functionality may include, but are not limited to, one or more of the following (or combinations thereof):
Detection of user interest in particular artist, brand and/or other criteria
Identification of user;
Detection of user input;
Detection of changes to available Digital Media Product;
Identification of available Digital Media Product matching selected criteria such as, for example, author criteria, brand criteria, etc.;
Detection of user's interest in purchasing or renting Digital Media Product (e.g., user clicks on DME/L icon)
Identification of Digital Media Product that user desires to purchase or rent or Flip;
Detection completed purchase/order transaction;
Determination of revenue sharing distributions;
Determination of bonus and/or award distributions;
Receiving updated database communications from external servers (e.g., Content Provider Servers)
Etc.

In at least one embodiment, a given instance of the DME/L System functionality may access and/or utilize information from one or more associated databases. In at least one embodiment, at least a portion of the database information may be accessed via communication with one or more local and/or remote memory devices. Examples of different types of data which may be accessed by the DME/L System functionality may include, but are not limited to, one or more different types of data, metadata, and/or other information described and/or referenced herein.

In at least one embodiment, a given instance of the DME/L System functionality may access and/or utilize information from one or more associated databases. In at least one embodiment, at least a portion of the database information may be accessed via communication with one or more local and/or remote memory devices. Examples of different types of data which may be accessed by the DME/L System functionality may include, but are not limited to, one or more of the following (or combinations thereof):
Brand-related information;
Digital Media Product availability information;
Pricing information;
User behavior and analytic information;
Performance information;
Inventory information;
Merchant information;
Supplier information;
Brand related taxonomy information;
Merchant subscription information;
Ecommerce related transaction information;
Order information;
Publisher/Content Provider information;
User profile information;
Merchant-brand association information;
etc.

It will be appreciated that the various embodiments of the DME/L Systems disclosed herein are but a few examples from a wide range of DME/L System embodiments which may be implemented. Other embodiments of the DME/L System (not shown) may include additional, fewer and/or different components/features that those illustrated and described herein.

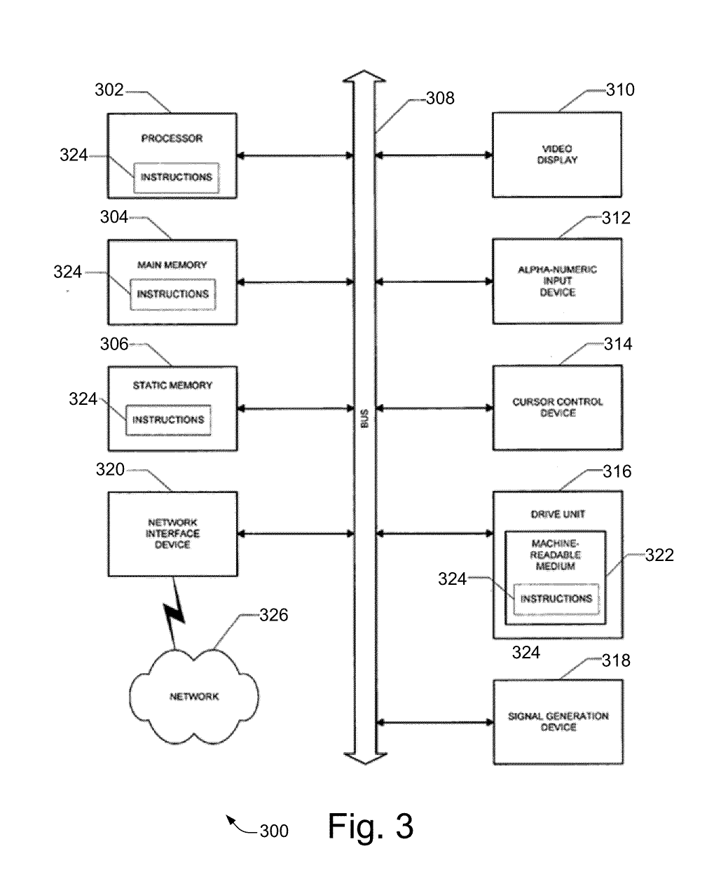

FIG. 3 shows a diagrammatic representation of machine in the exemplary form of a client (or end user) computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU), a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a user interface (UI) navigation device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions and data structures (e.g., software 324) embodying or utilized by any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320 utilizing any one of a number of well-known transfer protocols (e.g., HTTP).

While the machine-readable medium 322 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. Although an embodiment of the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

According to various embodiments, Client Computer System 300 may include a variety of components, modules and/or systems for providing various types of functionality. For example, in at least one embodiment, Client Computer System 300 may include a web browser application which is operable to process, execute, and/or support the use of scripts (e.g., JavaScript, AJAX, etc.), Plug-ins, executable code, virtual machines, HTML5 vector-based web animation (e.g., Adobe Flash), etc.

In at least one embodiment, the web browser application may be configured or designed to instantiate components and/or objects at the Client Computer System in response to processing scripts, instructions, and/or other information received from a remote server such as a web server. Examples of such components and/or objects may include, but are not limited to, one or more of the following (or combinations thereof):
UI Components such as those illustrated, described, and/or referenced herein.
Database Components such as those illustrated, described, and/or referenced herein.
Processing Components such as those illustrated, described, and/or referenced herein.
Other Components which, for example, may include components for facilitating and/or enabling the Client Computer System to perform and/or initiate various types of operations, activities, functions such as those described herein.

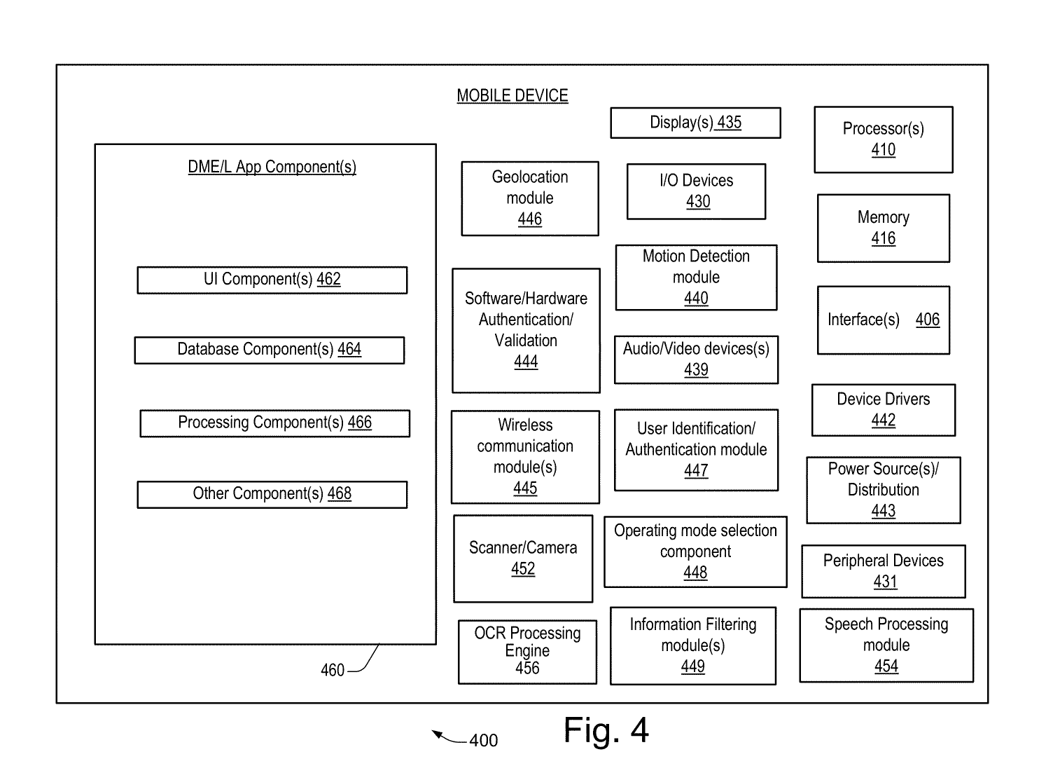

FIG. 4 is a simplified block diagram of an exemplary client system 400 in accordance with a specific embodiment. In at least one embodiment, the client system may include DME/L Mobile Device App Component(s) which have been configured or designed to provide functionality for enabling or implementing at least a portion of the various DME/L techniques at the client system.

According to specific embodiments, various aspects, features, and/or functionalities of the Mobile Device may be performed, implemented and/or initiated by one or more of the following types of systems, components, systems, devices, procedures, processes, etc. (or combinations thereof):
Processor(s) 410
Device Drivers 442
Memory 416
Interface(s) 406
Power Source(s)/Distribution 443
Geolocation module 446
Display(s) 435
I/O Devices 430
Audio/Video devices(s) 439
Peripheral Devices 431
Motion Detection module 440
User Identification/Authentication module 447
Client App Component(s) 460
Other Component(s) 468
UI Component(s) 462
Database Component(s) 464
Processing Component(s) 466
Software/Hardware Authentication/Validation 444
Wireless communication module(s) 445
Information Filtering module(s) 449
Operating mode selection component 448
Speech Processing module 454
Scanner/Camera 452
OCR Processing Engine 456
etc.

As illustrated in the example of FIG. 4 Mobile Device 400 may include a variety of components, modules and/or systems for providing various functionality. For example, as illustrated in FIG. 4, Mobile Device 400 may include Mobile Device Application components (e.g., 460), which, for example, may include, but are not limited to, one or more of the following (or combinations thereof):
UI Components 462 such as those illustrated, described, and/or referenced herein.
Database Components 464 such as those illustrated, described, and/or referenced herein.
Processing Components 466 such as those illustrated, described, and/or referenced herein.
Other Components 468 which, for example, may include components for facilitating and/or enabling the Mobile Device to perform and/or initiate various types of operations, activities, functions such as those described herein.

In at least one embodiment, the Mobile Device Application component(s) may be operable to perform and/or implement various types of functions, operations, actions, and/or other features such as, for example, one or more of those described and/or referenced herein.

According to specific embodiments, multiple instances or threads of the Mobile Device Application component(s) may be concurrently implemented and/or initiated via the use of one or more processors and/or other combinations of hardware and/or hardware and software. For example, in at least some embodiments, various aspects, features, and/or functionalities of the Mobile Device Application component(s) may be performed, implemented and/or initiated by one or more systems, components, systems, devices, procedures, processes, etc. (or combinations thereof) described and/or referenced herein.

According to different embodiments, one or more different threads or instances of the Mobile Device Application component(s) may be initiated in response to detection of one or more conditions or events satisfying one or more different types of minimum threshold criteria for triggering initiation of at least one instance of the Mobile Device Application component(s). Various examples of conditions or events which may trigger initiation and/or implementation of one or more different threads or instances of the Mobile Device Application component(s) may include, but are not limited to, one or more types of conditions and/or events described or referenced herein.

In at least one embodiment, a given instance of the Mobile Device Application component(s) may access and/or utilize information from one or more associated databases. In at least one embodiment, at least a portion of the database information may be accessed via communication with one or more local and/or remote memory devices. Examples of different types of data which may be accessed by the Mobile Device Application component(s) may include, but are not limited to, one or more different types of data, metadata, and/or other information described and/or referenced herein.

According to different embodiments, Mobile Device 400 may further include, but is not limited to, different types of components, modules and/or systems (or combinations thereof) such as, for example, one or more of those described and/or referenced herein.

According to different embodiments, Mobile Device 400 may further include, but is not limited to, one or more of the following types of components, modules and/or systems (or combinations thereof):
At least one processor 410. In at least one embodiment, the processor(s) 410 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of the client system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 416, which, for example, may include volatile memory (e.g., RAM), non-volatile memory (e.g., disk memory, FLASH memory, EPROMs, etc.), unalterable memory, and/or other types of memory. In at least one implementation, the memory 416 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the client system and/or other information relating to the functionality of the various DME/L techniques described herein. The program instructions may control the operation of an operating system and/or one or more applications, for example. The memory or memories may also be configured to store data structures, metadata, timecode synchronization information, audio/visual media content, asset file information, keyword taxonomy information, advertisement information, and/or information/data relating to other features/functions described herein. Because such information and program instructions may be employed to implement at least a portion of the DME/L techniques described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.
Interface(s) 406 which, for example, may include wired interfaces and/or wireless interfaces. In at least one implementation, the interface(s) 406 may include functionality similar to at least a portion of functionality implemented by one or more computer system interfaces such as those described herein and/or generally known to one having ordinary skill in the art. For example, in at least one implementation, the wireless communication interface(s) may be configured or designed to communicate with selected electronic game tables, computer systems, remote servers, other wireless devices (e.g., PDAs, cell phones, player tracking transponders, etc.), etc. Such wireless communication may be implemented using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
Device driver(s) 442. In at least one implementation, the device driver(s) 442 may include functionality similar to at least a portion of functionality implemented by one or more computer system driver devices such as those described herein and/or generally known to one having ordinary skill in the art.
At least one power source (and/or power distribution source) 443. In at least one implementation, the power source may include at least one mobile power source (e.g., battery) for allowing the client system to operate in a wireless and/or mobile environment. For example, in one implementation, the power source 443 may be implemented using a rechargeable, thin-film type battery. Further, in embodiments where it is desirable for the device to be flexible, the power source 443 may be designed to be flexible.
Geolocation module 446 which, for example, may be configured or designed to acquire geolocation information from remote sources and use the acquired geolocation information to determine information relating to a relative and/or absolute position of the client system.
Motion detection component 440 for detecting motion or movement of the client system and/or for detecting motion, movement, gestures and/or other input data from user. In at least one embodiment, the motion detection component 440 may include one or more motion detection sensors such as, for example, MEMS (Micro Electro Mechanical System) accelerometers, that can detect the acceleration and/or other movements of the client system as it is moved by a user.
User Identification/Authentication module 447. In one implementation, the User Identification module may be adapted to determine and/or authenticate the identity of the current user or owner of the client system. For example, in one embodiment, the current user may be required to perform a log in process at the client system in order to access one or more features. Alternatively, the client system may be adapted to automatically determine the identity of the current user based upon one or more external signals such as, for example, an RFID tag or badge worn by the current user which provides a wireless signal to the client system for determining the identity of the current user. In at least one implementation, various security features may be incorporated into the client system to prevent unauthorized users from accessing confidential or sensitive information.
One or more display(s) 435. According to various embodiments, such display(s) may be implemented using, for example, LCD display technology, OLED display technology, and/or other types of conventional display technology. In at least one implementation, display(s) 435 may be adapted to be flexible or bendable. Additionally, in at least one embodiment the information displayed on display(s) 435 may utilize e-ink technology (such as that available from E Ink Corporation, Cambridge, Mass., www.eink.com), or other suitable technology for reducing the power consumption of information displayed on the display(s) 435.
One or more user I/O Device(s) 430 such as, for example, keys, buttons, scroll wheels, cursors, touchscreen sensors, audio command interfaces, magnetic strip reader, optical scanner, etc.
Audio/Video device(s) 439 such as, for example, components for displaying audio/visual media which, for example, may include cameras, speakers, microphones, media presentation components, wireless transmitter/receiver devices for enabling wireless audio and/or visual communication between the client system 400 and remote devices (e.g., radios, telephones, computer systems, etc.). For example, in one implementation, the audio system may include componentry for enabling the client system to function as a cell phone or two-way radio device.
Other types of peripheral devices 431 which may be useful to the users of various client systems, such as, for example: PDA functionality; memory card reader(s); fingerprint reader(s); image projection device(s); social networking peripheral component(s); etc.
Information filtering module(s) 449 which, for example, may be adapted to automatically and dynamically generate, using one or more filter parameters, filtered information to be displayed on one or more displays of the mobile device. In one implementation, such filter parameters may be customizable by the player or user of the device. In some embodiments, information filtering module(s) 449 may also be adapted to display, in real-time, filtered information to the user based upon a variety of criteria such as, for example, geolocation information, contextual activity information, and/or other types of filtering criteria described and/or referenced herein.
Wireless communication module(s) 445. In one implementation, the wireless communication module 445 may be configured or designed to communicate with external devices using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
Software/Hardware Authentication/validation components 444 which, for example, may be used for authenticating and/or validating local hardware and/or software components, hardware/software components residing at a remote device, game play information, wager information, user information and/or identity, etc. Examples of various authentication and/or validation components are described in U.S. Pat. No. 6,620,047, titled, “ELECTRONIC GAMING APPARATUS HAVING AUTHENTICATION DATA SETS,” incorporated herein by reference in its entirety for all purposes.
Operating mode selection component 448 which, for example, may be operable to automatically select an appropriate mode of operation based on various parameters and/or upon detection of specific events or conditions such as, for example: the mobile device's current location; identity of current user; user input; system override (e.g., emergency condition detected); proximity to other devices belonging to same group or association; proximity to specific objects, regions, zones, etc. Additionally, the mobile device may be operable to automatically update or switch its current operating mode to the selected mode of operation. The mobile device may also be adapted to automatically modify accessibility of user-accessible features and/or information in response to the updating of its current mode of operation.
Scanner/Camera Component(s) (e.g., 452) which may be configured or designed for use in scanning identifiers and/or other content from other devices and/or objects such as for example: mobile device displays, computer displays, static displays (e.g., printed on tangible mediums), etc.
OCR Processing Engine (e.g., 456) which, for example, may be operable to perform image processing and optical character recognition of images such as those captured by a mobile device camera, for example.
Speech Processing module (e.g., 454) which, for example, may be operable to perform speech recognition, and may be operable to perform speech-to-text conversion.
Etc.

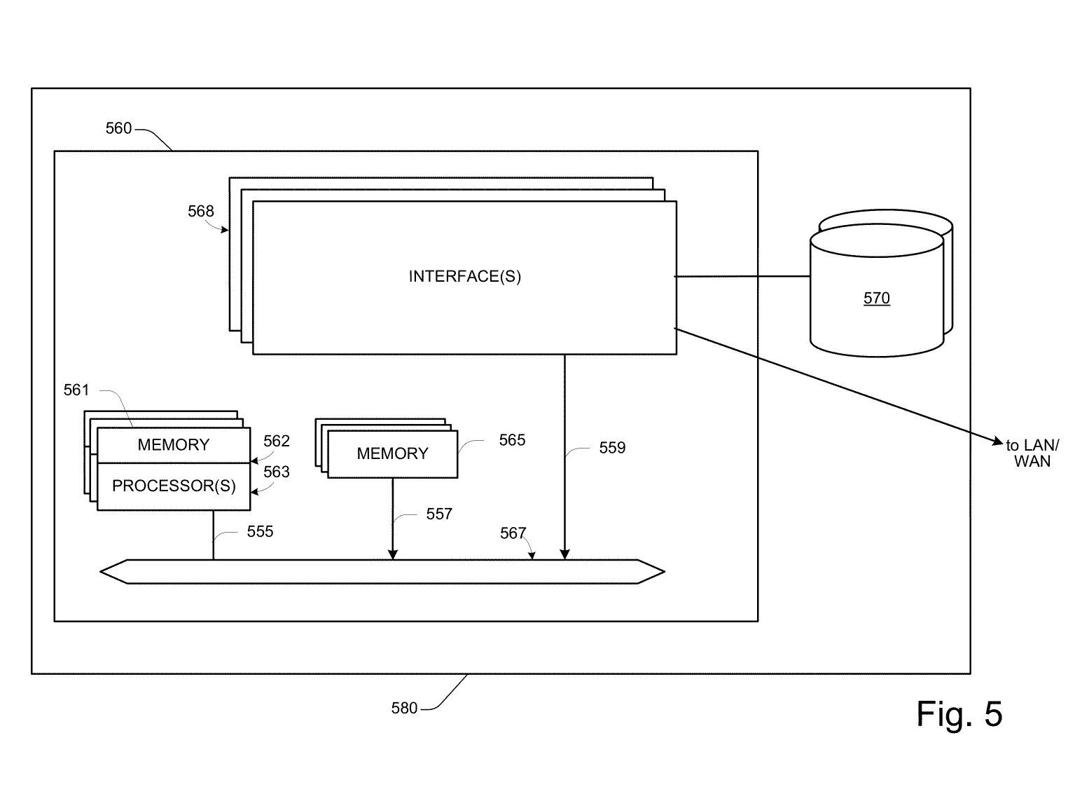

FIG. 5 illustrates an example embodiment of a server system 580 which may be used for implementing various aspects/features described herein. In at least one embodiment, the server system 580 includes at least one network device 560, and at least one storage device 570 (such as, for example, a direct attached storage device).

In one embodiment, server system 580 may be suitable for implementing at least some of the DME/L techniques described herein.

In according to one embodiment, network device 560 may include a master central processing unit (CPU) 562, interfaces 568, and a bus 567 (e.g., a PCI bus). When acting under the control of appropriate software or firmware, the CPU 562 may be responsible for implementing specific functions associated with the functions of a desired network device. For example, when configured as a server, the CPU 562 may be responsible for analyzing packets; encapsulating packets; forwarding packets to appropriate network devices; instantiating various types of virtual machines, virtual interfaces, virtual storage volumes, virtual appliances; etc. The CPU 562 preferably accomplishes at least a portion of these functions under the control of software including an operating system (e.g. Linux), and any appropriate system software (such as, for example, AppLogic™ software).

CPU 562 may include one or more processors 563 such as, for example, one or more processors from the AMD, Motorola, Intel and/or MIPS families of microprocessors. In an alternative embodiment, processor 563 may be specially designed hardware for controlling the operations of server system 580. In a specific embodiment, a memory 561 (such as non-volatile RAM and/or ROM) also forms part of CPU 562. However, there may be many different ways in which memory could be coupled to the system. Memory block 561 may be used for a variety of purposes such as, for example, caching and/or storing data, programming instructions, etc.

The interfaces 568 may be typically provided as interface cards (sometimes referred to as “line cards”). Alternatively, one or more of the interfaces 568 may be provided as on-board interface controllers built into the system motherboard. Generally, they control the sending and receiving of data packets over the network and sometimes support other peripherals used with the server system 580. Among the interfaces that may be provided may be FC interfaces, Ethernet interfaces, frame relay interfaces, cable interfaces, DSL interfaces, token ring interfaces, Infiniband interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like. Other interfaces may include one or more wireless interfaces such as, for example, 802.11 (WiFi) interfaces, 802.15 interfaces (including Bluetooth™), 802.16 (WiMax) interfaces, 802.22 interfaces, Cellular standards such as CDMA interfaces, CDMA2000 interfaces, WCDMA interfaces, TDMA interfaces, Cellular 3G interfaces, etc.

Generally, one or more interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 562 to efficiently perform routing computations, network diagnostics, security functions, etc.

In at least one embodiment, some interfaces may be configured or designed to allow the server system 580 to communicate with other network devices associated with various local area network (LANs) and/or wide area networks (WANs). Other interfaces may be configured or designed to allow network device 560 to communicate with one or more direct attached storage device(s) 570.

Although the system shown in FIG. 5 illustrates one specific network device described herein, it is by no means the only network device architecture on which one or more embodiments can be implemented. For example, an architecture having a single processor that handles communications as well as routing computations, etc. may be used. Further, other types of interfaces and media could also be used with the network device.

Regardless of network device's configuration, it may employ one or more memories or memory modules (such as, for example, memory block 565, which, for example, may include random access memory (RAM)) configured to store data, program instructions for the general-purpose network operations and/or other information relating to the functionality of the various DME/L techniques described herein. The program instructions may control the operation of an operating system and/or one or more applications, for example. The memory or memories may also be configured to store data structures, and/or other specific non-program information described herein.

Because such information and program instructions may be employed to implement the systems/methods described herein, one or more embodiments relates to machine readable media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that may be specially configured to store and perform program instructions, such as read-only memory devices (ROM) and random access memory (RAM). Some embodiments may also be embodied in transmission media such as, for example, a carrier wave travelling over an appropriate medium such as airwaves, optical lines, electric lines, etc. Examples of program instructions include both machine code, such as produced by a compiler, and files containing higher level code that may be executed by the computer using an interpreter.

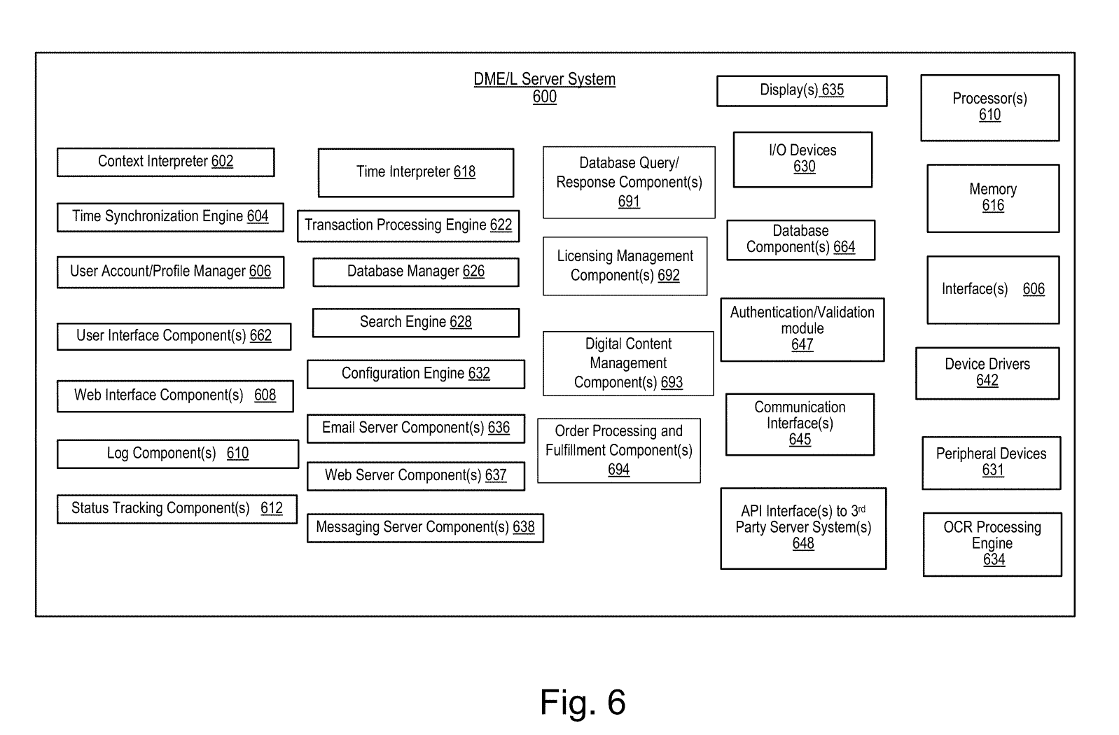

FIG. 6 illustrates an example of a functional block diagram of a DME/L Server System in accordance with a specific embodiment.

In at least one embodiment, the DME/L Server System may be operable to perform and/or implement various types of functions, operations, actions, and/or other features, such as, for example, one or more of those described and/or referenced herein.

In at least one embodiment, the DME/L Server System may include a plurality of components operable to perform and/or implement various types of functions, operations, actions, and/or other features such as, for example, one or more of those described and/or referenced herein.

In at least one embodiment, the DME/L Server System may include a plurality of components operable to perform and/or implement various types of functions, operations, actions, and/or other features such as, for example, one or more of the following (or combinations thereof):
Database Query/Response Component(s) 691
Licensing/Rental Management Component(s) 692
Digital Media Product Management Component(s) 693
Order Processing and Fulfillment Component(s) 694
Context Interpreter (e.g., 602) which, for example, may be operable to automatically and/or dynamically analyze contextual criteria relating to a detected set of event(s) and/or condition(s), and automatically determine or identify one or more contextually appropriate response(s) based on the contextual interpretation of the detected event(s)/condition(s). According to different embodiments, examples of contextual criteria which may be analyzed may include, but are not limited to, one or more of the following (or combinations thereof):
   location-based criteria (e.g., geolocation of client device, geolocation of agent device, etc.)
   time-based criteria
   identity of user(s)
   user profile information
   transaction history information
   recent user activities
   proximate business-related criteria (e.g., criteria which may be used to determine whether the client device is currently located at or near a recognized business establishment such as a bank, gas station, restaurant, supermarket, etc.)
   etc.
Time Synchronization Engine (e.g., 604) which, for example, may be operable to manages universal time synchronization (e.g., via NTP and/or GPS)
Search Engine (e.g., 628) which, for example, may be operable to search for transactions, logs, items, accounts, options in the DME/L databases
Configuration Engine (e.g., 632) which, for example, may be operable to determine and handle configuration of various customized configuration parameters for one or more devices, component(s), system(s), process(es), etc.
Time Interpreter (e.g., 618) which, for example, may be operable to automatically and/or dynamically modify or change identifier activation and expiration time(s) based on various criteria such as, for example, time, location, transaction status, etc.
Authentication/Validation Component(s) (e.g., 647) (password, software/hardware info, SSL certificates) which, for example, may be operable to perform various types of authentication/validation tasks such as, for example, one or more of the following (or combinations thereof):
   verifying/authenticating devices,
   verifying passwords, passcodes, SSL certificates, biometric identification information, and/or other types of security-related information
   verify/validate activation and/or expiration times
   etc.
      In one implementation, the Authentication/Validation Component(s) may be adapted to determine and/or authenticate the identity of the current user or owner of the mobile client system. For example, in one embodiment, the current user may be required to perform a log in process at the mobile client system in order to access one or more features. In some embodiments, the mobile client system may include biometric security components which may be operable to validate and/or authenticate the identity of a user by reading or scanning The user's biometric information (e.g., fingerprints, face, voice, eye/iris, etc.). In at least one implementation, various security features may be incorporated into the mobile client system to prevent unauthorized users from accessing confidential or sensitive information.
Transaction Processing Engine (e.g., 622) which, for example, may be operable to handle various types of transaction processing tasks such as, for example, one or more of the following (or combinations thereof):
   identifying/determining transaction type
   determining which payment gateway(s) to use
   associating databases information to identifiers
   etc.
OCR Processing Engine (e.g., 634) which, for example, may be operable to perform image processing and optical character recognition of images such as those captured by a mobile device camera, for example.
Database Manager (e.g., 626) which, for example, may be operable to handle various types of tasks relating to database updating, database management, database access, etc. In at least one embodiment, the Database Manager may be operable to manage databases, DME/L Device Application databases, etc.
Log Component(s) (e.g., 610) which, for example, may be operable to generate and manage transactions history logs, system errors, connections from APIs, etc.
Status Tracking Component(s) (e.g., 612) which, for example, may be operable to automatically and/or dynamically determine, assign, and/or report updated transaction status information based, for example, on the state of the transaction. In at least one embodiment, the status of a given transaction may be reported as one or more of the following (or combinations thereof): Completed, Incomplete, Pending, Invalid, Error, Declined, Accepted, etc.
Gateway Component(s) (e.g., 614) which, for example, may be operable to facilitate and manage communications and transactions with external Payment Gateways.
Web Interface Component(s) (e.g., 608) which, for example, may be operable to facilitate and manage communications and transactions with DME/L web portal(s).
API Interface(s) to DME/L Server System(s) (e.g., 646) which, for example, may be operable to facilitate and manage communications and transactions with API Interface(s) to DME/L Server System(s)
API Interface(s) to 3rd Party Server System(s) (e.g., 648) which, for example, may be operable to facilitate and manage communications and transactions with API Interface(s) to 3rd Party Server System(s)
OCR Processing Engine (e.g., 634) which, for example, may be operable to perform image processing and optical character recognition of images such as those captured by a mobile device camera, for example.
At least one processor 610. In at least one embodiment, the processor(s) 610 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of the mobile client system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 616, which, for example, may include volatile memory (e.g., RAM), non-volatile memory (e.g., disk memory, FLASH memory, EPROMs, etc.), unalterable memory, and/or other types of memory. In at least one implementation, the memory 616 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the mobile client system and/or other information relating to the functionality of the various Mobile Transaction techniques described herein. The program instructions may control the operation of an operating system and/or one or more applications, for example. The memory or memories may also be configured to store data structures, metadata, identifier information/images, and/or information/data relating to other features/functions described herein. Because such information and program instructions may be employed to implement at least a portion of the DME/L System techniques described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.
Interface(s) 606 which, for example, may include wired interfaces and/or wireless interfaces. In at least one implementation, the interface(s) 606 may include functionality similar to at least a portion of functionality implemented by one or more computer system interfaces such as those described herein and/or generally known to one having ordinary skill in the art.
Device driver(s) 642. In at least one implementation, the device driver(s) 642 may include functionality similar to at least a portion of functionality implemented by one or more computer system driver devices such as those described herein and/or generally known to one having ordinary skill in the art.
One or more display(s) 635. According to various embodiments, such display(s) may be implemented using, for example, LCD display technology, OLED display technology, and/or other types of conventional display technology. In at least one implementation, display(s) 635 may be adapted to be flexible or bendable. Additionally, in at least one embodiment the information displayed on display(s) 635 may utilize e-ink technology (such as that available from E Ink Corporation, Cambridge, Mass., www.eink.com), or other suitable technology for reducing the power consumption of information displayed on the display(s) 635.
Email Server Component(s) 636, which, for example, may be configured or designed to provide various functions and operations relating to email activities and communications.
Web Server Component(s) 637, which, for example, may be configured or designed to provide various functions and operations relating to web server activities and communications.
Messaging Server Component(s) 638, which, for example, may be configured or designed to provide various functions and operations relating to text messaging and/or other social network messaging activities and/or communications.
Etc.

### Example DME/L Procedures and Flow Diagrams

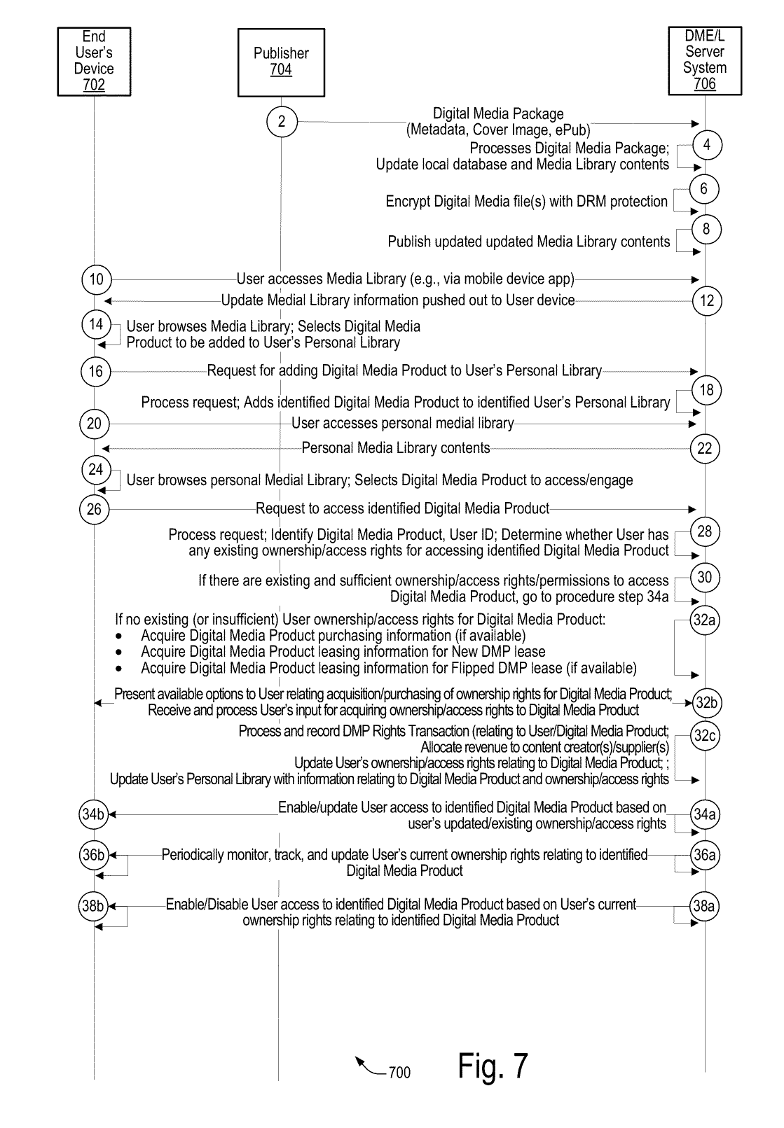

FIGS. 7-10 illustrate various example embodiments of different DME/L procedures and/or procedural flows which may be used for facilitating activities relating to one or more of the Digital Media Exchange/Lease aspects disclosed herein.

According to different embodiments, at least a portion of the various types of functions, operations, actions, and/or other features provided by the DME/L Procedures of FIG. 7-10 may be implemented at one or more client systems(s), at one or more server systems (s), and/or combinations thereof.

In at least one embodiment, one or more of the DME/L procedures may be operable to utilize and/or generate various different types of data and/or other types of information when performing specific tasks and/or operations. This may include, for example, input data/information and/or output data/information. For example, in at least one embodiment, the DME/L procedures may be operable to access, process, and/or otherwise utilize information from one or more different types of sources, such as, for example, one or more local and/or remote memories, devices and/or systems. Additionally, in at least one embodiment, the DME/L procedures may be operable to generate one or more different types of output data/information, which, for example, may be stored in memory of one or more local and/or remote devices and/or systems. Examples of different types of input data/information and/or output data/information which may be accessed and/or utilized by the DME/L procedures may include, but are not limited to, one or more of those described and/or referenced herein.

In at least one embodiment, a given instance of the DME/L procedures may access and/or utilize information from one or more associated databases. In at least one embodiment, at least a portion of the database information may be accessed via communication with one or more local and/or remote memory devices. Examples of different types of data which may be accessed by the DME/L procedures may include, but are not limited to, one or more of those described and/or referenced herein.

According to specific embodiments, multiple instances or threads of the DME/L procedures may be concurrently implemented and/or initiated via the use of one or more processors and/or other combinations of hardware and/or hardware and software. For example, in at least some embodiments, various aspects, features, and/or functionalities of the DME/L procedures may be performed, implemented and/or initiated by one or more of the various systems, components, systems, devices, procedures, processes, etc., described and/or referenced herein.

According to different embodiments, one or more different threads or instances of the DME/L procedures may be initiated in response to detection of one or more conditions or events satisfying one or more different types of minimum threshold criteria for triggering initiation of at least one instance of the DME/L procedures. Various examples of conditions or events which may trigger initiation and/or implementation of one or more different threads or instances of the DME/L procedures may include, but are not limited to, one or more of those described and/or referenced herein.

According to different embodiments, one or more different threads or instances of the DME/L procedures may be initiated and/or implemented manually, automatically, statically, dynamically, concurrently, and/or combinations thereof. Additionally, different instances and/or embodiments of the DME/L procedures may be initiated at one or more different time intervals (e.g., during a specific time interval, at regular periodic intervals, at irregular periodic intervals, upon demand, etc.).

In at least one embodiment, initial configuration of a given instance of the DME/L procedures may be performed using one or more different types of initialization parameters. In at least one embodiment, at least a portion of the initialization parameters may be accessed via communication with one or more local and/or remote memory devices. In at least one embodiment, at least a portion of the initialization parameters provided to an instance of the DME/L procedures may correspond to and/or may be derived from the input data/information.

FIG. 7 shows a specific example embodiment of an interaction diagram between various systems/devices, which may be utilized for implementing various aspects described herein. In at least one embodiment, the interaction diagram of FIG. 7 illustrates one example embodiment of how a user/client may utilize the hardware, software, and/or network components disclosed herein to facilitate, enable, initiate, and/or perform one or more of the Digital Media Exchange/Lease operation(s), action(s), and/or feature(s) described herein.

In the specific example embodiment of FIG. 7, procedural activities 2-8 relate to communications and information/data exchanges between the DME/L Server System (706) and one or more Publishers (704) and/or Content Providers. Procedural activities 10-38b relate to communications, exchanges, and/or transactions between an end user's device (702) and the DME/L Server System (706).

In the specific example embodiment of FIG. 7, it is assumed that the a software application (e.g., DME/L Application) running on the end user's device is configured or designed to include functionality for providing one or more DME/L-related GUIs for enabling the user to initiate and/or perform one or more of the various DME/L-related actions and/or operations described herein.

As shown at 2, Publisher 704 may provide the DME/L Server System with one or more Digital Media Packages relating to digital media which may be offered for lease or sale to end users. In at least one embodiment, a Digital Media Package may include one or more of the following type of data, metadata, and/or information (or combinations thereof):
digital media metadata;
cover image(s) or other digital image(s) relating to the digital media;
digital media file(s) (e.g., ePub file, audiobook file, video file, etc.) relating to the digital media;
updates regarding new titles and metadata such as, authors, rental pricing, purchase pricing information, category, etc.;
information relating to Digital Media Product rental terms and conditions, initial lease term, maximum allowable lease term, etc.;
metadata updates;
and/or other types of information/data/criteria relating to the digital media.

As shown at 4, the Digital Media Package may be processed at the DME/L Server System. In at least one embodiment, the processing of the Digital Media Package may include, but are not limited to, one or more of the following (or combinations thereof):
Black list checks;
White List checks;
Processing of publisher-specific rules, for example, relating to the sale and/or rental of one or more Digital Media Products;
Parsing Digital Media Package content;
Populating/updating one or more DME/L databases with new and/or updated DME/L-related information.

As shown at 6, the DME/L Server System may encrypt Digital Media file(s) with DRM protection. In at least one embodiment, the DRM protection may be used as a mechanism for controlling user access to the Digital Media Products. In one embodiment, a DME/L Application running on a user's device may be configured or designed to include functionality for providing controlled user access to the DRM protected Digital Media Products.

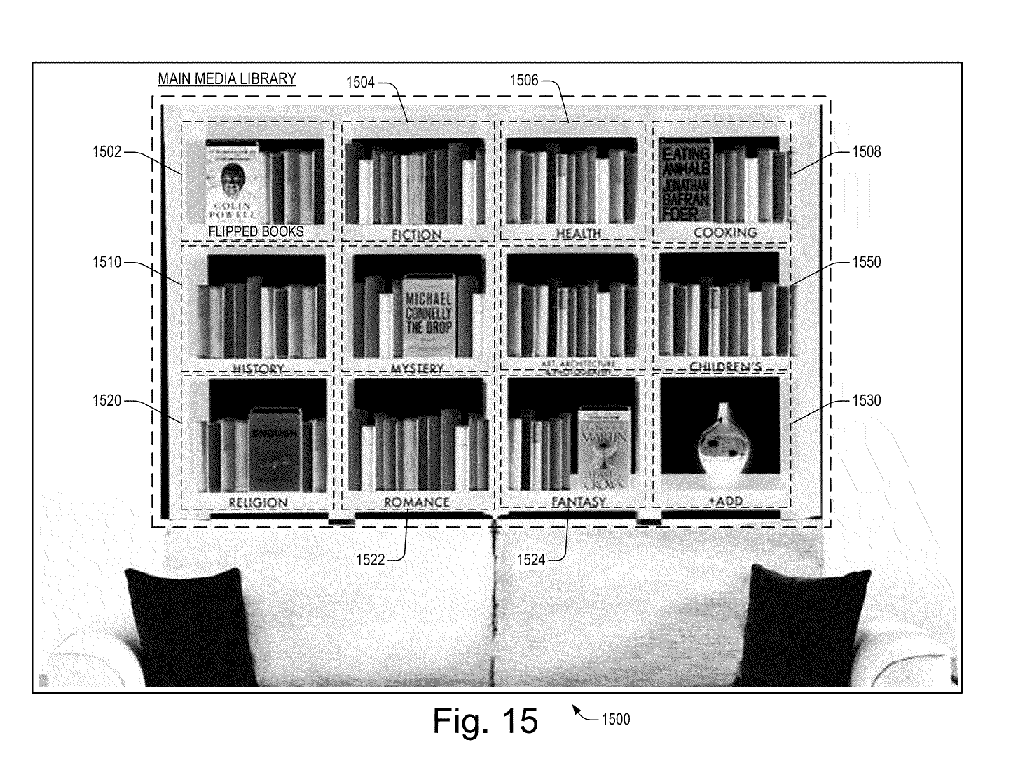

As shown at 8, the DME/L Server System may publish an updated catalog of its Media Library contents. In one embodiment, the published Media Library contents may include Digital Media Products which are available for sale or rental. In at least one embodiment, a Media Library GUI (e.g., such as that illustrated in FIG. 15) may be used to provide functionality for enabling a user to:
Browse the Digital Media Products of the Media Library.
Browse the Digital Media Products of the Flipped Pool Library (FPL).
Browse and access the contents and Digital Media Products of a user's Personal Media Library.
Check-Out (or rent/lease) one or more Digital Media Products of the Flipped Pool Library (FPL).
Purchase or rent/lease one or more Digital Media Products of the Media Library.
and/or other activities described and/or referenced herein.

As shown at 10, it is assumed that the user accesses (e.g., via an application running on the user's device 702) the DME/L Server System in order to access the Media Library and its contents (e.g., including the contents of the Flip Pool Library).

As shown at 12, the DME/L Server System may automatically push updated Medial Library information (including updated information relating to the Flip Pool Library) out to end user devices, including end user's device 702.

As shown at 14, the user may browse the contents of the Media Library and Flip Pool Library and select Digital Media Product(s) to be added to user's Personal Media Library (also referred to herein as the user's “Personal Library”). In at least one embodiment, the user's Personal Library may include a first set of Digital Media Products for which the user has valid ownership/access rights for accessing and/or engaging with the first set of Digital Media Products. In some embodiments, the user's Personal Library may also include a second set of Digital Media Products for which the user does have valid ownership/access rights for accessing and/or engaging with the second set of Digital Media Products. This second set of Digital Media Products may be viewed as being analogous to a user's “DMP Wish List”.

As shown at 16, the user may identify and request to add selected Digital Media Product to User's Personal Media Library.

As shown at 18, the DME/L Server System may process the user's request and add the identified Digital Media Product to the identified User's Personal Media Library. In some embodiments, the user may be permitted to the identified Digital Media Product to his/her Personal Library, even if the user does not yet have valid rights for accessing (or engaging with) the identified Digital Media Product.

As shown at 20, the user may request access his/her Personal Medial Library and/or other personalized user information.

As shown at 22, the DME/L Server System may provide user access to the user's Personal Media Library contents, and/or to other personalized user information associated with the identified user. In at least some embodiments, the DME/L Server System may automatically push out updated information relating to the user's Personal Library (and/or other personalized user information) to the end user's device 702, to thereby provide the user with “off-line” access to the user's Personal Library (and/or other personalized user information) without requiring a connection to the DME/L Server System.

As shown at 24, the user may browse the Personal Medial Library, and select a Digital Media Product to access/engage. In one embodiment, the user may provide input at device 702 to initiate a request to access identified Digital Media Product.

As shown at 26, in response to the user's input, the user's device may transmit a request to the DME/L Server System 706 to access the identified Digital Media Product (DMP).

As shown at 28, in response to receiving the user's DMP access request, the DME/L Server System may initiate and/or perform one or more of the following operation(s), action(s), and/or feature(s) (or combinations thereof):
Process the DMP access request.
Determine the Digital Media Product ID (for the identified Digital Media Product) and User ID (associated with the requesting user).
Determine if the user has any existing ownership/access rights for accessing identified Digital Media Product.

For example, in at least one embodiment, the DME/L Server System may use the Digital Media Product ID and User ID to perform a lookup to determine what (if any) rights does the user have with respect to the identified Digital Media Product. Examples of existing user ownership/access rights may include, but are not limited to, one or more of the following (or combinations thereof):
Permanent Ownership Rights—user has permanent rights for accessing the identified DMP. In one embodiment, such rights may be granted to a user who has purchased a given DMP.
Temporary Ownership/Access Rights—user has temporary rights for accessing the identified DMP. In one embodiment, such rights may be granted to a user who has leased or rented (or Checked-Out) a given DMP.
Limited Access Rights—user has limited rights for accessing the identified DMP. In one embodiment, such rights may be granted to a user for demonstration or promotional purposes. For example, a user may be granted a “Demo” or “Promotional” license to access a DMP for a limited time duration. In some embodiments, restrictions may be imposed on the user's access to one or more features and/or portions of content of the Digital Media Product (e.g., user only permitted to read the first chapter of a demo e-book; selected features/functions of the Digital Media Product disabled if DMP accessed under Demo/Promo license; etc.)

As shown at 30, the DME/L Server System may determine if the user has sufficient existing ownership/access rights for accessing the identified Digital Media Product. If it is determined that the user has sufficient existing ownership/access rights for accessing the identified Digital Media Product, procedural flow may continue at operational steps 34a, 34b of FIG. 7. If it is determined that the user does not have sufficient (or any existing) ownership/access rights for accessing the identified Digital Media Product, the DME/L Server System may initiate operational steps 32a, 32b, and 32c of FIG. 7.

As shown at 32a, if it is determined that the user does not have sufficient (or any existing) ownership/access rights for accessing the identified Digital Media Product, the DME/L Server System may automatically identify one or more available options or opportunities for the user to acquire the necessary rights for accessing the identified Digital Media Product, and may present such information to the user. Thus, for example, in one embodiment, if it is determined that the user does not have sufficient (or any existing) ownership/access rights for accessing the identified Digital Media Product, the DME/L Server System may initiate and/or perform one or more of the following operation(s), action(s), and/or feature(s) (or combinations thereof):
Acquire Digital Media Product purchasing information for purchasing DMP (if available).
Acquire Digital Media Product leasing and pricing information for purchasing a New Lease for the DMP (e.g., user may pay a fee to rent/lease a “new” copy of the DMP from the Media Library). In one embodiment, the lease conditions and lease term of the original DMP lease may be specified by the publisher and/or by the DME/L Server System.
Acquire Flipped Digital Media Product leasing and pricing information for purchasing a Flip lease for the DMP (from Flip Pool Library) (e.g., user may pay a fee to rent or Check-Out a Flipped copy of the DMP from the Flip Pool Library). This option may be subject to availability.

As shown at 32b, if it is determined that the user does not have sufficient (or any existing) ownership/access rights for accessing the identified Digital Media Product, the DME/L Server System may present available options to the user for obtaining or acquiring ownership/access rights to the identified Digital Media Product. Examples of such options may include, but are not limited to, one or more of the following (or combinations thereof):
Option to pay a fee to purchase copy of DMP (if available).
Option to pay a fee to rent/lease a “new” copy of the DMP from the Media Library.
Option to pay a fee to rent/lease/Check-Out a Flipped copy of the DMP from the Flip Pool Library (if available).
Option to obtain a Demo or Promo license granting limited rights for accessing DMP (if available).
etc.

The user may select one of the listed options for acquiring ownership/access rights to the identified Digital Media Product, and the DME/L Server System may process the user's input, and initiate one or more actions for acquiring/purchasing ownership/access rights to the DMP in accordance with the user's input selection.

As shown at 32c, if it is determined that the user does not have sufficient (or any existing) ownership/access rights for accessing the identified Digital Media Product, the DME/L Server System may initiate and/or perform one or more of the following operation(s), action(s), and/or feature(s) (or combinations thereof):
Initiate a DMP Rights Transaction for acquiring/purchasing ownership/access rights to the DMP in accordance with the user's input selection.
Process and record DMP Rights Transaction relating to User ID/Digital Media Product ID.
Distributing or allocating a portion of the Purchase/Rental Fee to the publisher of the Digital Media Product.
If the DMP Rights Transaction relates to the rental/lease/Check-Out of a Flipped copy of the DMP from the Flip Pool Library, allocate or distribute a portion of the DMP Rental Fee to the content creator(s), author(s), publisher(s) and/or supplier(s) of the leased FPL Digital Media Product. For example, according to different embodiments, content creators and/or content providers may receive a share of the revenues generated from monetization of the “secondary market” of Flipped Digital Media Products. Because publishers can earn extra royalties from relicensing their content as “Flipped” content, there is a financial incentive for them to participate and allow their DMPs to be Flipped. This revenue sharing approach is significantly different from conventional rental techniques in which the DMPs' content creators and/or content providers do not receive any share of the revenues generated from the rental of the DMPs which they created.
Create/update the user's ownership/access rights for the identified Digital Media Product in accordance with the processed DMP Rights Transaction.
Update User's Personal Media Library with information relating to Digital Media Product and ownership/access rights.

As shown at 34a/34b, the DME/L Server System and/or DME/L App (e.g., running on the end user's device 702) may enable/update user access to identified Digital Media Product based on the user's updated and/or existing ownership/access rights. For example, if the user purchased a new lease for renting a selected e-book for 7 days, the user may browse his/her Personal Media Library via the DME/L Application running on the user's device, and may be permitted to download the leased e-book to the users device, and to access the downloaded e-book for a period of 7 days.

As shown at 36a/36b, the user's current ownership/access rights relating to the identified Digital Media Product may be periodically monitored, tracked, and/or updated. According to different embodiments, these activities may be performed at the DME/L Server System and/or at the user's device (e.g., via the DME/L Application). In at least one embodiment, this may include calculating and tracking the remaining lease time associated with any leased DMPs. For example, if the user initially rented an e-book for 7 days, and 2 days has since elapsed (e.g., since the completion of the DMP lease transaction), the remaining lease time for the leased DMP may be updated to 5 days. In other embodiments, the remaining lease time for the leased DMP may be expressed using the expiration date/time of the current DMP lease (which typically will not require updating, unless the expiration date/time of the DMP lease has been modified or extended).

As shown at 38a/38b, the DME/L Server System and/or DME/L App may enable/disable User access to identified Digital Media Product based on User's current ownership rights relating to identified Digital Media Product. For example, if it is determined that user's current ownership rights for accessing given Digital Media Product have expired (e.g., due to expiration of DMP lease) and/or have been transferred (e.g., due to DMP being Flipped into Flip Pool Library), user access to Digital Media Product may be disabled at the DME/L Server System and/or at the user's device 702.

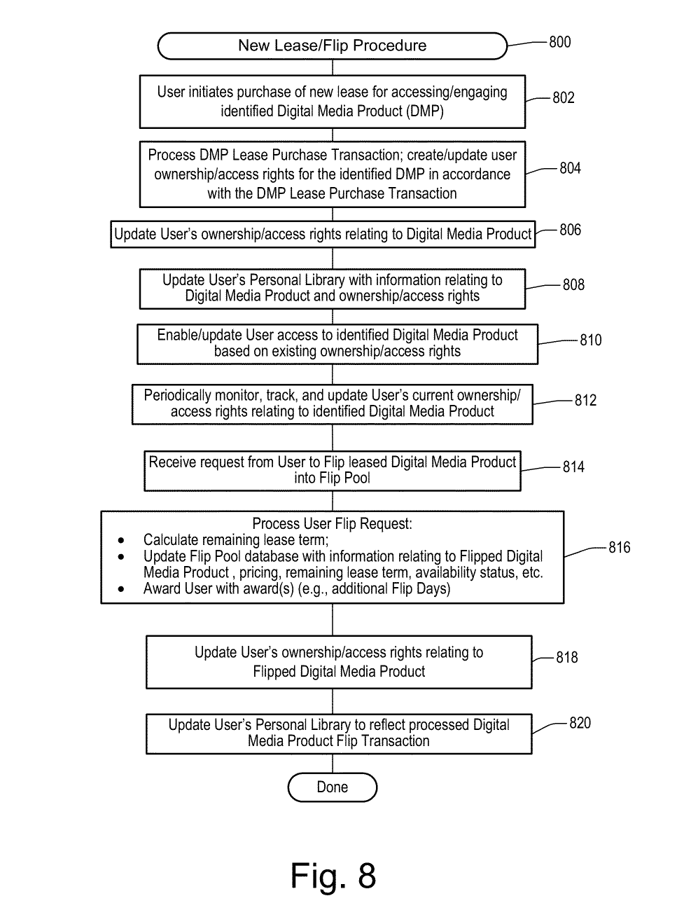

FIG. 8 shows a flow diagram of a New Lease/Flip Procedure in accordance with a specific embodiment. In at least one embodiment, the New Lease/Flip Procedure may be configured or designed to include functionality for: (i) enabling user to initiate new rental transactions for Digital Media Products, whereby a user may purchase a new lease (e.g., pay a rental fee) for acquiring temporarily limited access and/or ownership rights to an identified Digital Media Product (“DMP”), and (ii) transferring (herein referred to as “Flipping”) the user's remaining ownership/access rights of the leased DMP into a pool of previously leased Digital Media Products (herein referred to as a “Flip Pool”). As described in greater detail herein, the Digital Media Products which are available in the Flip Pool may be leased to (or “checked out” by) other users for a limited duration of time, thereby enabling additional monetization of the previously leased Digital Media Products of the Flip Pool.

According to different embodiments, at least a portion of the various types of functions, operations, actions, and/or other features provided by the New Lease/Flip Procedure may be implemented at one or more client systems(s), at one or more server systems (s), and/or combinations thereof. For example, in at least one embodiment, at least a portion of the New Lease/Flip Procedure may be implemented at the DME/L Server System in response to interaction with user who is accessing the DME/L Server System via a DME/L Application running on the user's mobile device.

In the specific example embodiment of FIG. 8, it is assumed at 802 that a user has identified a specific Digital Media Product (e.g., an e-book) with which the user desires to access/engage (e.g., user desires to read identified e-book). It is further assumed that the user accesses the DME/L Server System to initiate a purchase of a new Lease Transaction for renting the identified DMP (e-book) for a specified time period (e.g., 7 days). In at least one embodiment, the processing of the

As shown at 804, the DME/L Server System may process the user's DMP Lease Purchase Transaction. In at least one embodiment, the processing of the DMP Lease Purchase Transaction may include facilitating, enabling, initiating, and/or performing one or more of the following operation(s), action(s), and/or feature(s) (or combinations thereof):
Charging the user a fee for renting/leasing the identified DMP. For example, in one embodiment, the user may be charged a “New Lease” fee (e.g., $3.99) for leasing the identified DMP for 7 days.
Distributing or allocating a portion of the New Lease fee to the publisher of the identified DMP.
Creating/updating the user's ownership/access rights for the identified DMP in accordance with the DMP Lease Purchase Transaction.
and/or other activities such as one or more of those illustrated at 806, 808, 810 of FIG. 8, and/or described elsewhere herein.

As shown at 806, the DME/L Server System may update user's ownership/access rights relating to Digital Media Product. For example, in the present example, the DME/L Server System may update the identified user's ownership/access rights relating to the leased e-book to allow the identified e-book to be downloaded to the users mobile device and accessed by the user for a period of 7 days.

As shown at 808, the DME/L Server System may update user's Personal Media Library with information relating to Digital Media Product and ownership/access rights. This may include, for example, populating the user's Personal Media Library with new and/or updated information relating to the e-book which was leased/rented by the user. Such information may include, for example, one or more of the following (or combinations thereof):
DMP title information;
DMP author information;
Remaining lease/rental time;
DMP image/thumbnail;
and/or other types of information described and/or referenced herein.

As shown at 810, the DME/L Server System may enable user access to the leased DMP based on the user's updated and/or existing ownership/access rights. In at least one embodiment, the user may browse his/her Personal Media Library via the DME/L Application running on the user's mobile device, and may be allowed to download the leased e-book to the users mobile device, and to access the downloaded e-book for a period of 7 days.

As shown at 812, the user's current ownership/access rights relating to the identified Digital Media Product may be periodically monitored, tracked, and/or updated. According to different embodiments, these activities may be performed at the DME/L Server System and/or at the user's device. In at least one embodiment, this may include calculating and tracking the remaining lease time associated with the leased DMP. For example, if the DMP was originally leased for 7 days, and 2 days has elapsed (e.g., since the completion of the DMP lease transaction), the remaining lease time for the leased DMP may be updated to 5 days.

In the specific example embodiment of FIG. 8, it is assumed, for purposes of illustration, that the user wishes to Flip the leased DMP into the Flip Pool. Accordingly, as shown at 814, the DME/L Server System may receive request from the user to Flip the leased DMP into the Flip Pool.

As shown at 816, the DME/L Server System may process user's DMP Flip Request. In at least one embodiment, the processing of the user's DMP Flip Request may include one or more of the following operations/activities (or combinations thereof):
Calculate remaining lease time associated with the leased DMP;
Calculate a “Check Out” price to be charged to a user for checking out the Flipped, leased DMP from the Flip Pool;
Update the Flip Pool database with information relating to the Flipped Digital Media Product, including, for example, pricing information, remaining lease term (e.g., 5 days), availability status (e.g., “Available” or “Checked Out”), etc.
Award user with award(s) (e.g., additional Flip Days) as a reward and/or incentive for the user Flipping the leased DMP into the Flip Pool.

As shown at 818, the DME/L Server System may update user's ownership/access rights relating to the Flipped Digital Media Product. For example, after the Flip Transaction for the leased DMP has been completed (and the leased DMP has been added to the Flip Pool), the user's ownership rights and access rights to the leased DMP may be updated to reflect that such rights have expired, or have been rescinded, or are no longer valid.

As shown at 820, the DME/L Server System may update user's Personal Media Library to reflect processed Digital Media Product Flip Transaction. For example, after the Flip Transaction for the leased DMP has been completed (and the leased DMP has been added to the Flip Pool), the user's Personal Media Library may be updated to reflect that the user no longer has access to the leased DMP which as Flipped into the Flip Pool. Additionally, if the user has been awarded additional “Flip Days” for the Digital Media Product Flip Transaction, the user's total accumulated Flip Days amount may be updated accordingly.

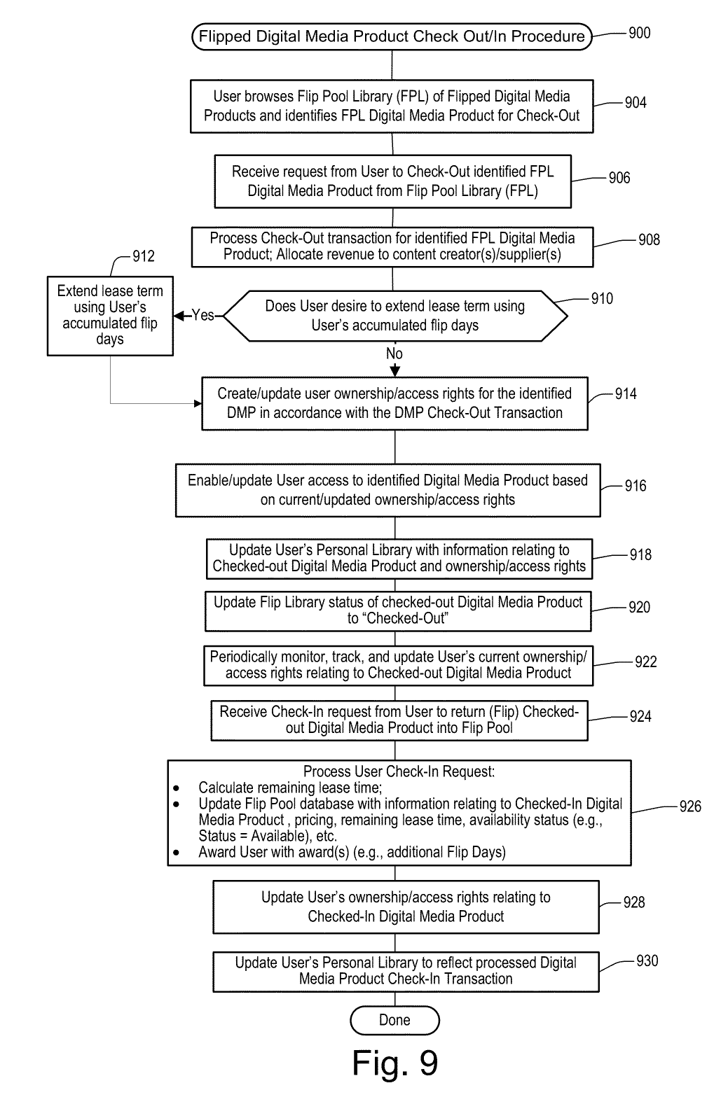

FIG. 9 shows a flow diagram of a Flipped Digital Media Product Check Out/In Procedure in accordance with a specific embodiment. In at least one embodiment, the Flipped Digital Media Product Check Out/In Procedure may be configured or designed to include functionality for: (i) enabling users to initiate Flipped Digital Media Product Check-Out transactions, in which a user is able to pay a fee to rent, lease or Check-Out one or more for Digital Media Products from the Flip Pool, thereby acquiring temporarily limited access and/or ownership rights to one or more of the Flip Pool's Digital Media Product (“DMP”). Additionally, the Flipped Digital Media Product Check Out/In Procedure may be configured or designed to include functionality for enabling a user to initiate a Flip (or Check-In) transaction for transferring the user's remaining ownership/access rights of a leased DMP back into the Flip Pool (herein referred to as a “Check-In” transaction. As described in greater detail herein, the Digital Media Products which are available in the Flip Pool may be leased to (or “checked out” by) other users for a limited duration of time, thereby enabling additional monetization of the previously leased Digital Media Products of the Flip Pool. In at least one embodiment, if there is additional remaining lease time remaining on the DMP which was Checked Out by the user, the user may elect to Flip (or Check-In) the DMP back into the Flip Pool.

According to different embodiments, at least a portion of the various types of functions, operations, actions, and/or other features provided by the Flipped Digital Media Product Check Out/In Procedure may be implemented at one or more client systems(s), at one or more server systems (s), and/or combinations thereof. For example, in at least one embodiment, at least a portion of the Flipped Digital Media Product Check Out/In Procedure may be implemented at the DME/L Server System in response to interaction with user who is accessing the DME/L Server System via a DME/L Application running on the user's mobile device.

In the specific example embodiment of FIG. 9, it is assumed at 904 that user browses the Flip Pool Library (FPL) of previously leased Digital Media Products (which still have remaining time available on their respective leases), and identifies and selects a Digital Media Product from the FPL for Check-Out. For reference purposes, the identified Digital Media Product may be referred to herein as the FPL Digital Media Product (Flip Pool Library Digital Media Product).

In at least one embodiment, each Digital Media Product in the FPL may correspond to a previously leased DMP which has been Flipped by a previous user into the FPL. Additionally, each FPL Digital Media Product may have associated with it a respective “remaining lease time” value (or respective “lease expiration” value), which may be based on the remaining lease time of the prior user's lease of the DMP. For example, a first user may initiate a New Lease Transaction and pay a “New Rental Fee” (e.g., $3.99) to rent or lease a selected e-book for 7 days. Four days later, the first user may initiate a DMP Flip Transaction to Flip the e-book into the Flip Pool. At this point, the remaining least time of the e-book is 3 days (7 days−4 days). The Flipped e-book may be added to the FPL catalog of available DMPs, along with its associated remaining lease time information, and pricing information for renting or leasing the DMP from the FPL. A second user then desires to rent or Check-Out the Flipped e-book from the FPL. The second user may initiate a Check-Out Transaction, and pay a reduced rental fee (e.g., $1.99) to rent the Flipped e-book for a time period corresponding to the DMP's remaining lease time (e.g., 3 days) associated with the DMP's previous lease. After the Check-Out Transaction has been completed, the status of the Flipped e-book in the FPL may be updated to “Checked Out”, meaning that the e-book is currently checked out to another user not available for rental. One day later, the second user may initiate a DMP Flip Transaction to Flip the e-book into the Flip Pool (also referred to as a DMP “Check-In” Transaction). At this point, the remaining least time of the e-book is now 2 days (7 days−4 days−1 day). After the DMP Check-In Transaction has been completed, the status of the e-book in the FPL may be updated to “Available”. A third user who desires to rent or Check-Out the Flipped e-book from the FPL, may initiate a Check-Out Transaction, and pay a reduced rental fee (e.g., $0.99) to rent the Flipped e-book for a time period corresponding to the DMP's remaining lease time (e.g., 2 days).

In at least one embodiment, the user may initiate the DMP Check-Out transaction via the user's mobile device. In the specific example embodiment of FIG. 9, it is assumed that a user initiates a request (via a DME/L Application running on the user's mobile device) to check out a selected e-book from the Flip Pool Library. As shown at 906, the DME/L Server System may receive the user's DMP Check-Out request to Check-Out the identified Digital Media Product from the Flip Pool Library (“FPL”).

As shown at 908, the DME/L Server System may process Check-Out Transaction for identified Flip Pool Library's Digital Media Product (herein “FPL Digital Media Product”). In at least one embodiment, the processing of the Check-Out Transaction may include facilitating, enabling, initiating, and/or performing one or more of the following operation(s), action(s), and/or feature(s) (or combinations thereof):
Charging the user a “Flipped” Rental Fee for leasing (or Checking Out) the FPL Digital Media Product. For example, in one embodiment, the user may be charged a specified rental or Check-Out fee (e.g., $1.99) for leasing the FPL Digital Media Product from the FPL. In at least one embodiment, the term of the FPL Digital Media Product lease may be initially set to correspond to the remaining available lease time associated with the FPL Digital Media Product's previous lease.
Distributing or allocating a portion of the Flipped Rental Fee to the publisher of the leased FPL Digital Media Product.
Allocate a portion of the Flipped Rental Fee to the content creator(s), author(s), publisher(s), and/or supplier(s) of the leased FPL Digital Media Product. For example, according to different embodiments, content creators and/or content providers may receive a share of the revenues generated from monetization of the “secondary market” of Flipped Digital Media Products. Because publishers can earn extra royalties from relicensing their content as “Flipped” content, there is a financial incentive for them to participate and allow their DMPs to be Flipped. This revenue sharing approach is significantly different from conventional rental techniques in which the DMPs' content creators and/or content providers do not receive any share of the revenues generated from the rental of the DMPs which they created.
Creating/updating the user's ownership/access rights for the identified FPL Digital Media Product in accordance with the DMP Lease Purchase Transaction.
and/or other activities such as one or more of those illustrated at 910, 912, 914, 916, 918, 920 of FIG. 9, and/or described elsewhere herein.

As shown at 910, the DME/L Server System may determine if user desires to extend lease term using user's accumulated flip days. In at least one embodiment, during the Check-Out Transaction, the user may be presented with an opportunity to extend the lease term of the FPL Digital Media Product to be checked out from the FPL. In some embodiments, the user may be presented with an opportunity to pay an additional fee in order to purchase additional lease time. In some embodiments, the user may be presented with an opportunity to extend the DMP's lease term using at least a portion of the user's accumulated Flip Days. For example, if remaining lease time of the DMP identified for Check-Out is 2 days, and the user has accumulated a total of 14 Flip Days (e.g., via prior DMP Flip Transactions), the user may be provided with an opportunity to use a portion of the user's Flip Days (e.g., up to 5 Flip Days) to extend the lease term for the DMP Check-Out Transaction by a desired number of days (e.g., up to 5 days) not to exceed a maximum allowable lease term (e.g., 7 days). In one embodiment, the maximum allowable lease term may be defined by the maximum allowable lease term (or the initial lease term) associated with the purchase of a New Lease for the identified DMP.

As shown at 912, if the user desires to extend lease term using user's accumulated Flip Days, the DME/L Server System may extend lease term using a specified number of user's accumulated Flip Days. Alternatively, if the user does not desire to extend lease term, then the lease term for the Checked-Out DMP may be set based on the DMP's remaining lease time value. Another way of stating this is that, if the user does not desire to extend lease term, then the expiration date/time for the Checked-Out DMP may be set to correspond to the expiration date/time of the DMP's previous lease.

As shown at 914, DME/L Server System may create/update user ownership/access rights for the identified DMP in accordance with the DMP Check-Out Transaction.

As shown at 916, the DME/L Server System may enable/update user access to the Checked Out Digital Media Product based on the user's updated and/or current ownership/access rights.

As shown at 918, the DME/L Server System may update user's Personal Media Library with information relating to Checked-out Digital Media Product and ownership/access rights

As shown at 920, after the DMP Check-Out Transaction has been completed, the DME/L Server System may update the FPL status of the Checked Out DMP to “Checked Out”, to thereby reflect that the identified DMP is currently checked out to another user not available for rental from the FPL. However, in at least some embodiments, the FPL may include other Flipped copies of the identified DMP which are available for rental.

As shown at 922, the user's current ownership/access rights relating to the leased Digital Media Product may be periodically monitored, tracked, and/or updated. According to different embodiments, these activities may be performed at the DME/L Server System and/or at the user's device. In at least one embodiment, this may include calculating and tracking the remaining lease time associated with the leased DMP. For example, if the lease term for the DMP was 5 days at the time of Check-Out, and 2 days has since elapsed, the remaining lease time for the leased DMP may be updated to 3 days.

In the specific example embodiment of FIG. 9, it is assumed, for purposes of illustration, that the user wishes to Flip the leased DMP into the Flip Pool. In one embodiment, the user may initiate a DMP Check-In Transaction to Flip (or Check-In) the leased DMP back into the Flip Pool Library. Accordingly, as shown at 924, the DME/L Server System may receive request from the user to Flip (or Check-In) the leased DMP into the Flip Pool.

As shown at 926, the DME/L Server System may process user's DMP Check-In Request. In at least one embodiment, the processing of the user's DMP Flip Request may include one or more of the following operations/activities (or combinations thereof):
Calculate a remaining lease time associated with the leased DMP;
Calculate a “Check Out” price to be charged to a subsequent user for Checking Out the DMP from the Flip Pool Library;
Update the Flip Pool Library database with information relating to the Checked-In Digital Media Product, including, for example, pricing information, remaining lease time (e.g., 5 days), availability status (e.g., “Available” or “Checked Out”), etc.
Award user with award(s) (e.g., additional Flip Days) as a reward and/or incentive for the user Flipping the leased DMP into the Flip Pool.

As shown at 928, the DME/L Server System may update user's ownership/access rights relating to the Flipped Digital Media Product. For example, after the DMP Check-In Transaction has been completed (and the DMP has been Flipped back into the Flip Pool), the user's ownership rights and access rights to the leased DMP may be updated to reflect that such rights have expired, or have been rescinded, or are no longer valid. Additionally, the DME/L Server System may update the availability status of the identified FPL DMP to “Available”, meaning that the DMP is currently available to be Checked Out or rented by other users.

As shown at 930, the DME/L Server System may update user's Personal Media Library to reflect processed Digital Media Product Flip Transaction. For example, after the DMP Check-In Transaction for the leased DMP has been completed), the user's Personal Media Library may be updated to reflect that the user no longer has access to that particular DMP. Additionally, if the user has been awarded additional “Flip Days” for the Flip Transaction, the user's total accumulated Flip Days amount may be updated accordingly.

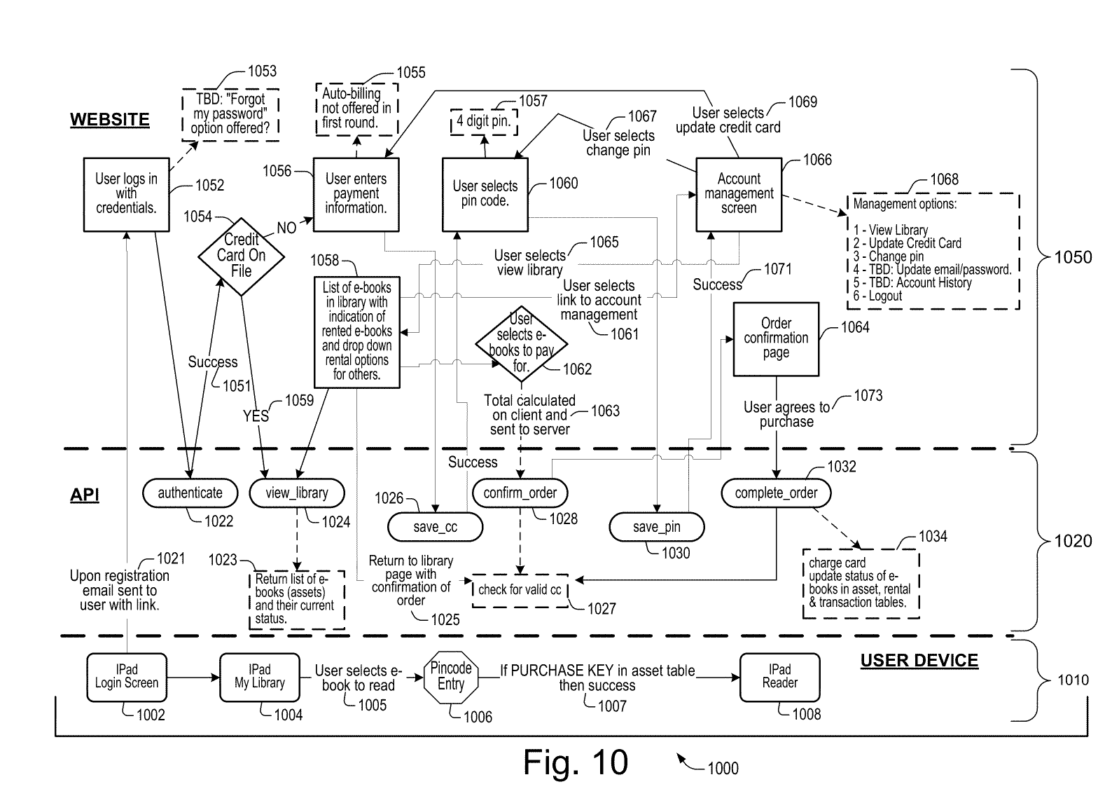

FIG. 10 shows an example of a DME/L State Diagram in accordance with a specific embodiment. The example DME/L State Diagram 1000 of FIG. 10 provides an example illustration of the various operating states and state-change conditions/events which may occur at the DME/L Server System (e.g., including Website portion 1050, and API portion 1020) and/or end user's device 1010. In this specific example, it is assumed that a user accesses an application (e.g., mobile application) on the user's device (e.g., iPad) and initiates/performs a series of operations to rent one or more e-book(s) from the DME/L Server System.

### Flip Pricing & Incentives & Revenue Sharing

### Determination of Flipped DMP Pricing

According to different embodiments, the Flipped DMP Rental (or Check-Out) fee amount which is assigned to a given DMP in the Flip Pool Library may be statically determined or dynamically calculated (e.g., in real-time). For example, dynamic Pricing may be utilized to help motivate slow movers, and maximize revenue for in-demand content. A variety of different factors and/or criteria may be taken into consideration when dynamically determining or calculating the Flipped DMP Rental fee amount to be assigned to a given DMP in the Flip Pool Library, such as, for example, one or more of the following (or combinations thereof):
Amount of remaining lease time associated with the DMP. For example, in one embodiment, the value of the Flipped DMP Rental fee amount for a given DMP may be proportional to (or related to) the amount of remaining lease time for that DMP. By way of example, the fee for renting a first copy of a Flipped e-book with 6 remaining lease days may be set at $2.99, whereas the fee for renting a second copy of the Flipped e-book with 4 remaining lease days may be set at $1.99, and the fee for renting a third copy of the Flipped e-book with 3 remaining lease days may be set at $0.99.
Amount charged for New lease of DMP (e.g., fee amount charged for renting/leasing a “new” copy of the DMP from the Media Library)
Season of Year
User ID
User demographic data
User location
User age
User gender
News cycle\current events
Holiday
Day of Week
Time of Day
Third Party Bestseller Lists (e.g., NYT Bestseller List)
Book popularity (e.g., as rated by users)
Number of available copies of the same DMP in the Flip Pool Library
Number of users who have placed book in their library without renting
Factors relating to the user's social network influence such as, for example:
   Number of friends on Face-book
   Number of followers on Twitter
Number of rents/flips associated with a given user (e.g., similar to status tiers)
User Backlist vs Frontlist renting and Flip preferences and habits
Publisher generated dynamic pricing (e.g., promotions)
and/or other desired criteria

### Dynamic Rewards

According to different embodiments, various types of incentivizing schemes may be implemented within the Digital Media Exchange and Licensing System to motivate and users to Flip their leased Digital Media Products into the Flip Pool Library. For example, one such incentivizing scheme involves awarding users with a specified number of Flip Days in response to the user Flipping his/her leased DMP into the Flip Pool Library. A user may continue to accumulate additional Flip Days for each DMP which the user Flips into the Flip Pool Library. In one embodiment, the user may use a portion of his/her accumulated Flip Days to extend the lease term on one or more selected Flipped Digital Media Products which the user desires to Check-Out from the Flip Pool Library. For example, during a DMP Check-Out Transaction, the user may be presented with an opportunity to extend the DMP's lease term by using a specified number of the user's accumulated Flip Days. For example, if remaining lease time of the DMP identified for Check-Out is 2 days, and the user has accumulated a total of 14 Flip Days (e.g., via prior DMP Flip Transactions), the user may be provided with an opportunity to use a portion of the user's Flip Days (e.g., up to 5 Flip Days) to extend the lease term for the DMP Check-Out Transaction by a desired number of days (e.g., up to 5 days) not to exceed a maximum allowable lease term (e.g., 7 days). In one embodiment, the maximum allowable lease term may be defined by the maximum allowable lease term (or the initial lease term) associated with the purchase of a New Lease for the identified DMP.

In at least one embodiment, the number of Flip Days awarded to a user for completing a DMP Flip Transaction may be automatically and dynamically determined, for example, based on variety of different factors and/or criteria such as one or more of those described above with respect to the calculation of the Flipped DMP Rental fee amount. Dynamic Rewards motivate users to be active participants in the secondary market created by the Flipped Digital Media Products. Thus, for example, when a given Digital Media Product is determined to be in high demand, the DME/L Server System may automatically and dynamically increase the value of the reward(s) (e.g., increase the number of Flip Days) offered for Flipping a copy of that Digital Media Product into the Flip Pool Library, thereby providing additional incentives to the user to motivate the user to Flip the Digital Media Product into the Flip Pool Library. Similarly, when a given Digital Media Product is determined not to be in high demand, the DME/L Server System may automatically and dynamically decrease the value of the reward(s) (e.g., decrease the number of Flip Days) offered for Flipping a copy of that Digital Media Product into the Flip Pool Library.

Additional incentivizing schemes or programs may also be implemented to reward users for posting, promoting and/or broadcasting their Flip-related activities at one or more social networks (e.g., such as Facebook, Twitter, etc.). For example, in some embodiments, users may be awarded with additional Flip Days for posting their Flip-related activities at one or more social networks. Additionally, in some embodiments, if a user Flips a Digital Media Product into the Flip Pool Library, and the DME/L Server System detects that a social network friend of the user Checks-Out a copy of the same DMP from the Flip Pool Library, the DME/L Server System may award both parties of the transactions (e.g., Flipor receives additional Flip Days, and Flipee receives a lease term extension on the DMP which was Checked-Out from the Flip Pool Library).

Additional incentivizing schemes or programs may also be implemented to reward users for posting reviews of Digital Media Products within the DME/L System.

### Revenue Allocation

According to specific embodiments, content creators and/or content providers may receive a share of the revenues generated from monetization of the “secondary market” of Flipped Digital Media Products. Because publishers may earn extra royalties from relicensing their content as “Flipped” content, there is a financial incentive for them to participate and allow their DMPs to be Flipped and monetized. This revenue sharing approach is significantly different from conventional rental techniques in which the DMPs' content creators and/or content providers do not receive any share of the revenues generated from the rental of the DMPs which they created. Moreover, using the Digital Media Exchange and Licensing techniques described herein, a “secondary market” eco system may be developed and perpetuated for licensing and re-licensing of Digital Media Products in which the end users may serve as intermediary distributors (and re-distributors) of content in a mutually beneficial arrangement with content creators. Additionally, this “secondary market” eco system provides content owners and/or content creators with the ability to generate multiple streams of revenue from a single DMP rental.

### Other Aspects/Features/Benefits/Advantages

According to different embodiments, at least some embodiments of the DME/L Systems disclosed herein may be configured, designed, and/or operable to provide, enable and/or facilitate one or more of the following aspects, features, functionalities, benefits and/or advantages (or combinations thereof)
Flip pricing may be based on relative ranking of Digital Media Products in provider database(s).
Users may be rewarded for contributing content to the Flip Pool Library and may also receive additional rewards if content is acquired from the Flip Pool Library.
Flip pricing for a given DMP in the Flip Pool Library may be automatically and dynamically adjusted based on updated remaining lease time value(s) associated with that DMP. For example, in one embodiment, the DME/L Server System may automatically and dynamically lower the Flip pricing (e.g., Check-Out fee) for the DMP in response to detecting that the remaining lease time associated with the DMP has decreased by a specified amount of time.
Rewards to the “Flipor” may be based on how long a DMP remains in the Flip Pool Library.
Pricing may be relative to the amount of other similar titles in the Flip Pool Library.
Rewards or pricing in the Flip Pool Library may be seasonal based on the title and/or genre. For example, Flipping Christmas e-books may earn more rewards during the Christmas/Winter Holiday Season (e.g., November-December) than during other months (e.g., January-October).
Reward incentives may be based on the relative perceived “interest” in a given DMP Title. For example, in one embodiment, the DME/L Server System may be configured or designed to track the amount of searches and “views” titles and genre's receive. The DME/L Server System may then determine that there is an increased interest (and value) in those titles, and, in response, may automatically and dynamically increase the incentive(s) to Flip those titles into the Flip Pool Library because of their perceived value to users. In some embodiments, this reward technique may be implemented on a per customer basis. For example, in one embodiment, the DME/L Server System may be configured or designed to track a customer's interest in a certain title and then dynamically incentive a direct user-to-user Flip for that title.

Although the various Digital Media Exchange and Licensing techniques disclosed herein have been described primarily with respect to the leasing of digital media products such as e-books, it will be appreciated that such techniques may also be applied to other types of products and/or services (e.g., for monetizing idle rental time) such as, for example, one or more of the following (or combinations thereof):
audio book rentals;
digital video rentals;
digital music rentals;
video game rentals;
DVD rentals;
CD rentals;
vehicle rentals (e.g., for monetizing unused vehicle rental time);
vacation home rentals;
rentals involving physical goods/merchandise such as for example:
   tool rentals;
   wardrobe/costume rentals;
   etc.
and/or other types of goods/services which may be leased or rented.

### Example GUIs and Screenshots

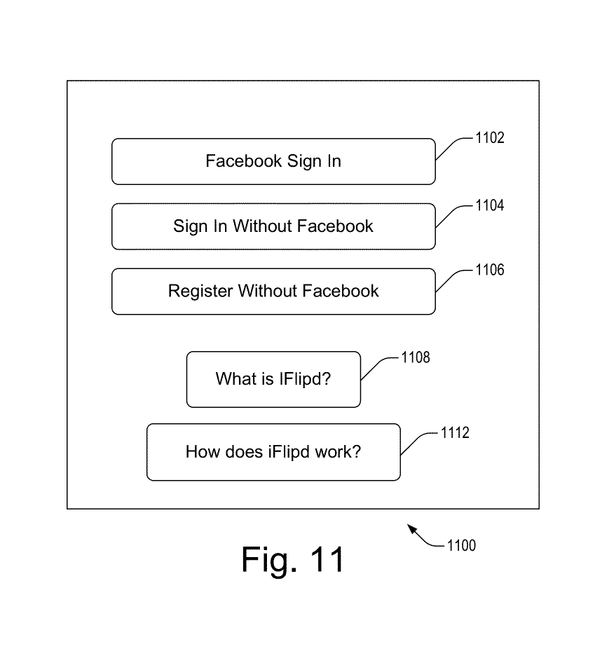

FIGS. 11-28 illustrate example screenshots of various GUIs which may be used for facilitating activities relating to one or more of the Digital Content Exchange aspects disclosed herein. In at least one embodiment, at least a portion of the GUIs may be configured or designed for use at one or more mobile devices. The example GUI screenshots of FIGS. 11-28 are intended to help further illustrate and describe at least some of the various types of functions, operations, actions, and/or other features which may be provided by the various component(s) of the DME/L System. In the example GUI screenshots of FIGS. 11-28, the DME/L System is referred to by its commercial brand name “iFlipd”.

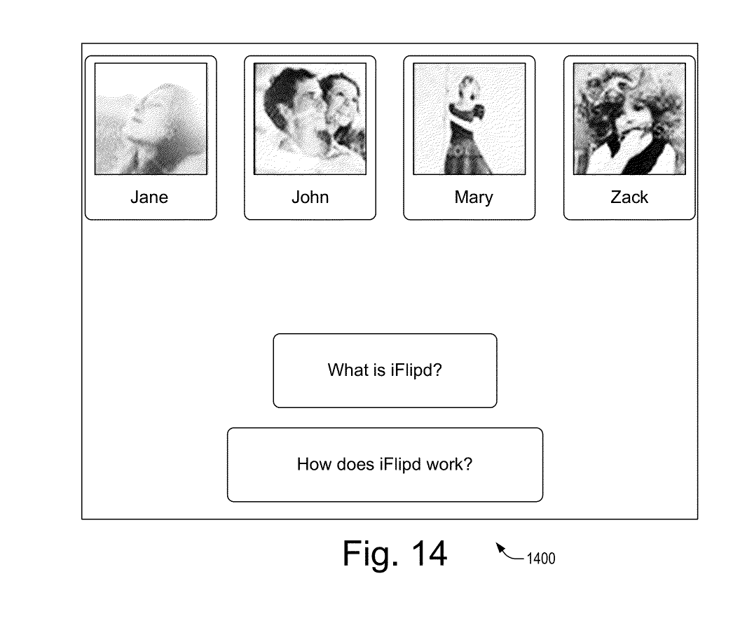

FIG. 11 illustrates an example screenshot of a Sign In graphical user interface (GUI) 1100 in accordance with a specific embodiment. (herein referred to as “iFlipd”). As illustrated in the example GUI embodiment of FIG. 11, user may create an account before using the GUI application. If account is active, user signs either through Facebook 1102 or through unique user login created at registration 1104. The option “forgot password” emails a password reset link. Video links “What is iFlipd?” and “How does iFlipd work?” replay produced videos. If user is not yet registered they may do so. If it is the first time a user is signing into the GUI application, user is directed to the additional registration steps of “Invite Friends” and “Create Your Bookcase”. If not the first time using the GUI application, user directed to the Main Media Library (e.g., “My Collections” GUI, FIG. 15). If there are multiple users on registered on the account, user directed to “Sign in—Multiple User” GUI (FIG. 14).

Other features and/or functionality which may be accessed via the Sign In GUI may include, but are not limited to, one or more of the following (or combinations thereof):
Providing seemless integration with Facebook and ability to import friends.
Instruction and help with iFlipd and how the system works.
iFlipd asks for a birthdate when you register in order to confirm age for COPPA compliance.

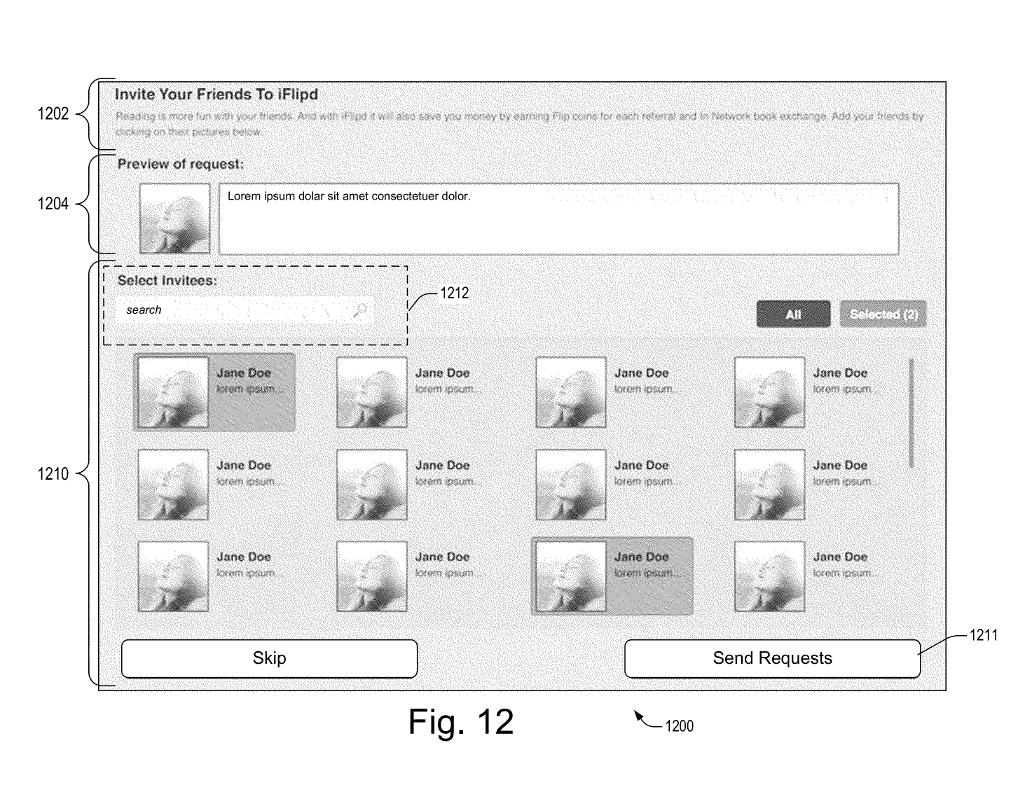

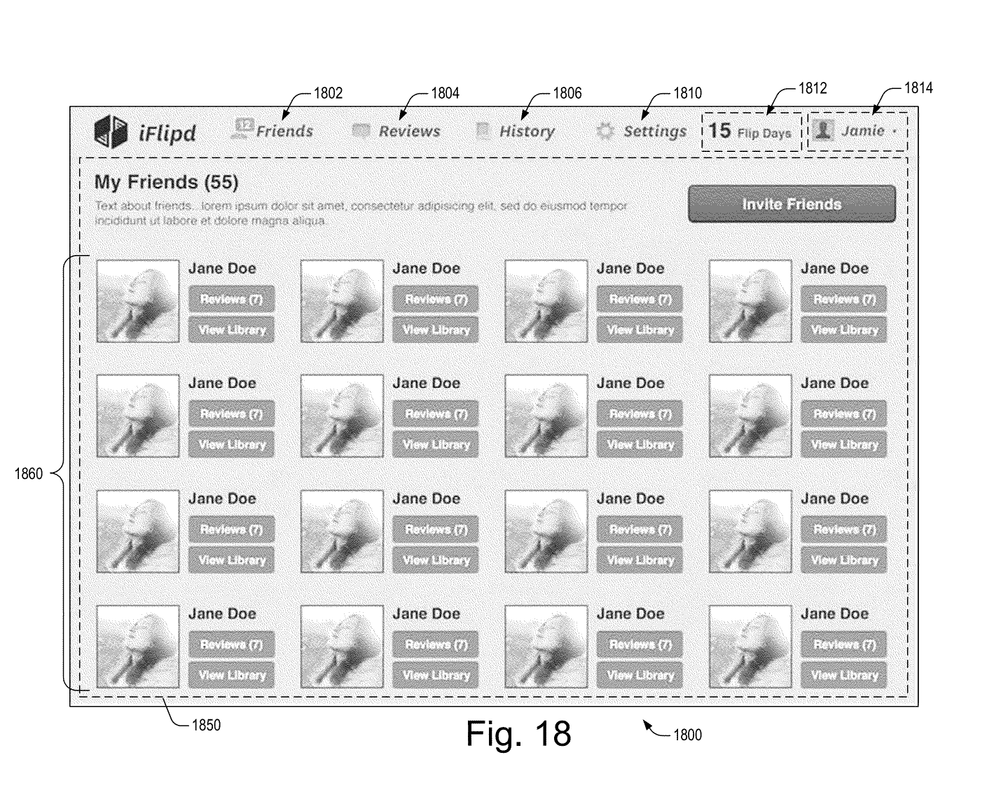

FIG. 12 illustrates an example screenshot of a Friend Invitation GUI 1200 in accordance with a specific embodiment. As illustrated in the example GUI embodiment of FIG. 12, user may invite friends 1210 generated through Facebook login. User may preview and edit pre made request text 1204. User taps friends to select from Facebook. User may search for particular friends 1212 and filter between showing all friends and only filtered sets of friends. User may skip adding friends at this point and do it later from the “My Account—Friends” GUI (FIG. 18). User may choose to “Send Requests” 1211 or may skip and invite later from the My Account—Friends” GUI (FIG. 18)

Other features and/or functionality which may be accessed via the Friend Invitation GUI may include, but are not limited to, one or more of the following (or combinations thereof):
Quickly import friends directly into iFlipd.
Share and expose iFlipd to one or more of your Facebook friends and get rewarded for it with additional Flip Days.

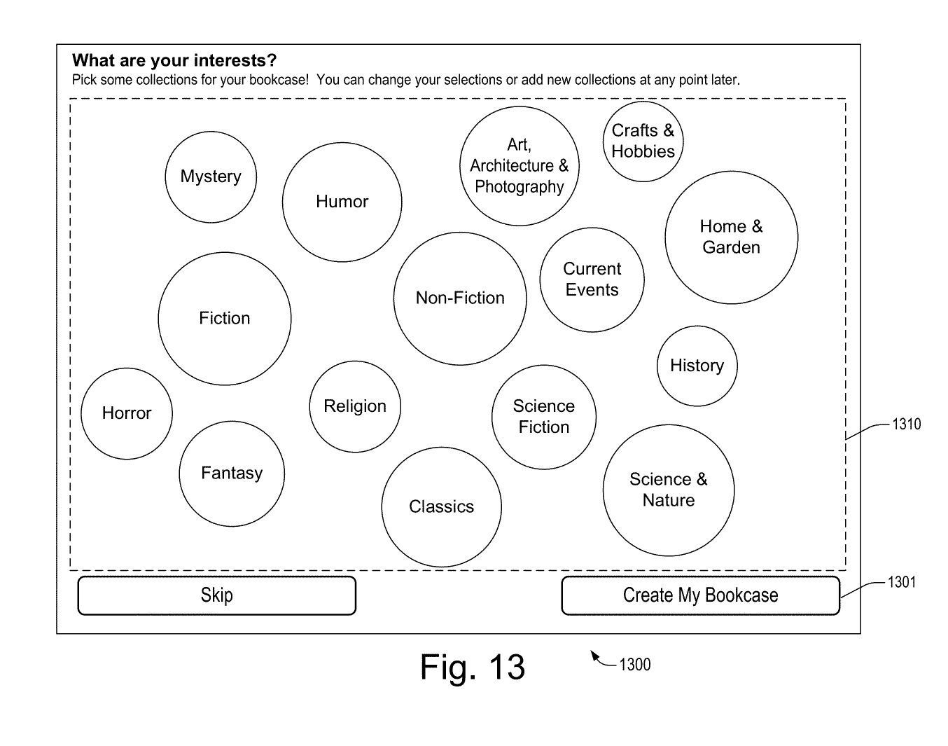

FIG. 13 illustrates an example screenshot of a Bookcase Creation GUI 1300 in accordance with a specific embodiment. In the example GUI embodiment of FIG. 13, the user may select (tap) desired collections 1310 which the user may want to create bookshelves for on “My Bookcase” GUI (FIG. 15). User may create their own bookcase category label. User may add books to this category through the “Add to Collection” option. User may skip creating shelves at this point. When user skips this step, “My Bookcase” populated with a generic set of collections. User may change later. When user hits “Create My Bookcase” button 1301, it brings them to the home GUI, “My Bookcase” GUI

Other features and/or functionality which may be accessed via the Bookcase Creation GUI may include, but are not limited to, one or more of the following (or combinations thereof):
When user taps an interest, the bubble pops and changes to an image that matches that collection.
Allows users to easily set up their library based on individual interests.

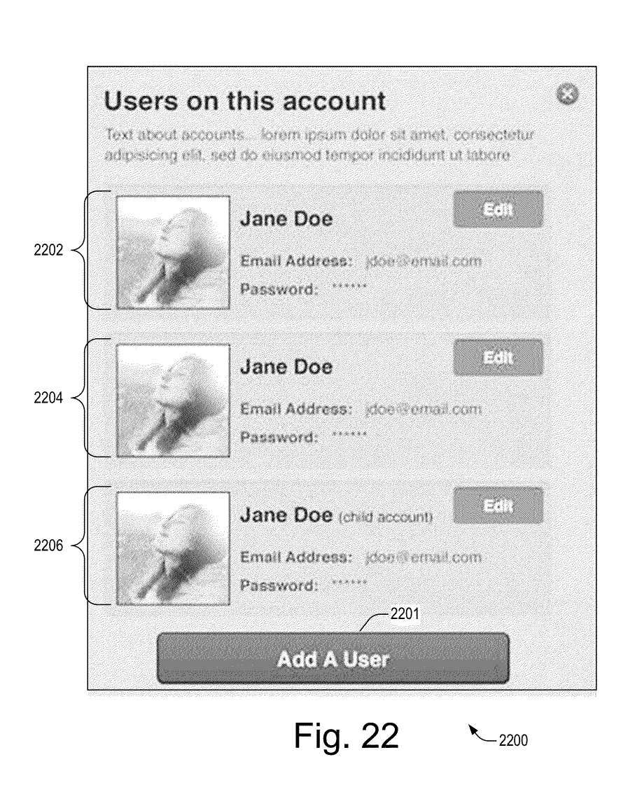

FIG. 14 illustrates an example screenshot of a Multiple User Sign In GUI 1400 in accordance with a specific embodiment. As illustrated in the example GUI embodiment of FIG. 14, when there are multiple users on a single account, user selects his or her “profile”. One or more personalized or customized aspects of the GUI application are then populated based on the user profile which has been selected. Additional users may be added in the “Account—Users” GUI (FIG. 22) GUI. The first time a newly added user accesses their account, they would go to the added steps of “Invite Friends” and “Create Bookcase”. If a profile may may require a password, the user box may zoom forward to the center of the page and password field may be exposed. User may access “What is iFlipd?” and “How does iFlipd work?” videos.

Other features and/or functionality which may be accessed via the Multiple User Sign In GUI may include, but are not limited to, one or more of the following (or combinations thereof):
Multiple users on at least one account allows users the ability to separate libraries, recommendations, interests, and friends.
Creates privacy among users while still complying with COPPA.
One or more charges to one credit card held by the admin user.
Parents are able to see child accounts and manage them.
Users are password protected unless children.

FIG. 15 illustrates an example screenshot of a My Bookcase GUI 1500 in accordance with a specific embodiment. In one embodiment, the My Bookcase GUI may be configured or designed to provide user access to the Main Media Library of the iFlipd System. As illustrated in the example GUI embodiment of FIG. 15, any time after first time sign in, user lands on “My Bookcase”, including the user's top collections chosen at “Book Case Creation” (FIG. 13). When a particular “collection” is chosen, user is directed to the specific “Collections” GUI. User may tap “Add” 1530 to add a collection to this GUI. If user selects more collections than may be displayed, user may scroll down to see additional collections. Through slide down menu from top, user may access links to “Friends, “Reviews”, “History”, “Settings”, “ ” Flip Days” and “User Name”, etc. Through slide out menu on left, user may search for books by title, author or genre, share an image of their bookcase, add or re-order collections, or access one or more of iFlipd's collections. Both menues are accessable from most GUI application screens. As illustrated in the example embodiment of FIG. 15, user may select or tap the “Flipped Books” icon 1502 to access the Flip Pool Library collection.

In one embodiment, the published Media Library contents may include Digital Media Products which are available for sale or rental. In at least one embodiment, a Media Library GUI (e.g., such as that illustrated in FIG. 15) may be used to provide functionality for enabling a user to:
Browse the Digital Media Products of the Media Library.
Browse the Digital Media Products of the Flipped Pool Library (FPL).
Browse and access the contents and Digital Media Products of a user's Personal Library.
Check-Out (or rent/lease) one or more Digital Media Products of the Flipped Pool Library (FPL).
Purchase or rent/lease one or more Digital Media Products of the Media Library.
and/or other activities described and/or referenced herein.

Other features and/or functionality which may be accessed via the My Bookcase GUI may include, but are not limited to, one or more of the following (or combinations thereof):
Serves as a navigation GUI for multiple unique collections.
Forward facing books allow marketing real estate for publishers and authors.
Multiple rooms may eventually be implemented to allow users to select their own room and personalize their reading space.

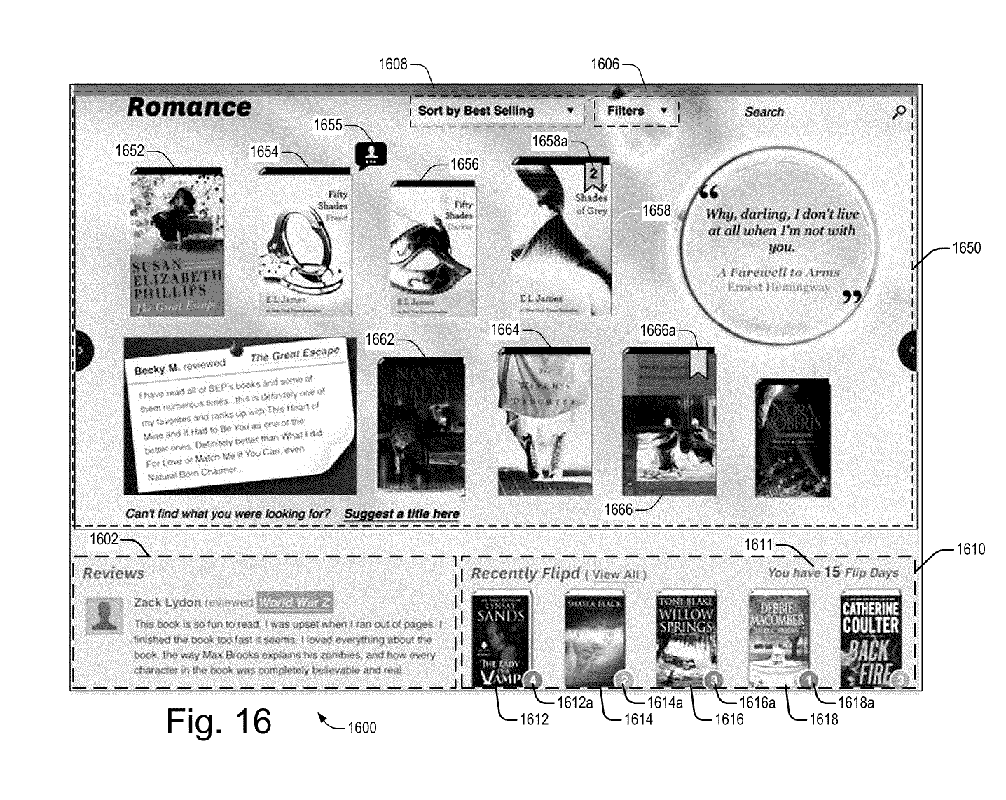

FIG. 16 illustrates an example screenshot of a Collection GUI 1600 in accordance with a specific embodiment. As illustrated in the example GUI embodiment of FIG. 16, the GUI may be configured or designed using a “Collection” type template. User may sort collection, add filters, or search within the collection. Books populate GUI based upon user sorts 1608 and filters 1606 or by “Best Selling” default. User may scroll through “new” (or “non-Flipped”) books section 1650, and may select to further access a particular title. Books swipe left to right. Books may include badges (e.g., 1658a, 1666a), to denote relevant information such as, for example: Rented, Owned, In-Network review(s), Flips available, Number of rental days remaining (also referred to as remaining lease time) (e.g., 1658a indicates 2 rental days remaining for e-book 1658), etc. If user chooses a book from this page they are directed to “Book Detail” GUI (25).

GUI portion 1602 displays information about social updates, in-network community activity, such as reviews, ratings, and facebook commenting, etc.

GUI portion 1610 displays recently Fliped books (e.g., 1612, 1614, 1616, 1618 within the current category (e.g., Romance), both in and out of network. Color and/or numerical coded badges (e.g., 1612a, 1614a, 1616a, 1618a) may be shown to indicate current lease term (e.g., remaining lease days) for a given book. Colors may be used to indicate additional information such as, for example: network affiliation (e.g., in-network, out of network), friendship affiliation, popularity, etc.

Collection GUI 1600 may also display the user's current value of accumulated Flip Days 1611.

Other features and/or functionality which may be accessed via the Collection GUI may include, but are not limited to, one or more of the following (or combinations thereof):
Users may suggest a title of a book that is missing from the collection to encourage publishers to give iFlipd content.
Photorealistic collections enhance the user experience and create an immersive feel within the GUI application.
Users may share elements of the collection to social networks.
Reviews and book quotes may be available one or more GUI pages.

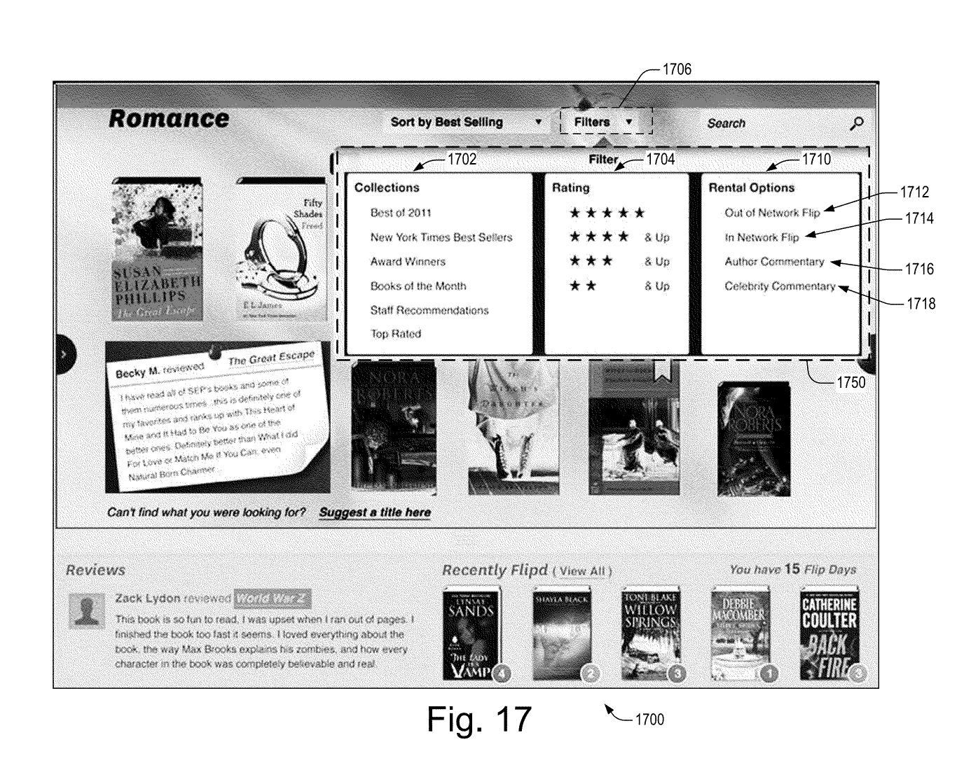

FIG. 17 illustrates an example screenshot of a Collections—Filter Options GUI 1700 in accordance with a specific embodiment. As illustrated in the example GUI embodiment of FIG. 17, user may select multiple filters (e.g., 1702, 1704, 1710, 1712, 1714, 1716, 1718) at a time to sort collection.

Other features and/or functionality which may be accessed via the Collections—Filter Options GUI may include enabling users to specifically narrow down the searches for a particular title, genre, author, date, rating, commentary, and/or specialty list.

FIG. 18 illustrates an example screenshot of My Friends GUI 1800 in accordance with a specific embodiment. In at least one embodiment, user gains access to My Friends GUI by tapping “Friends” link from top slide down menu from one or more screens. “Invite Friends” tab 1802 allows user to invite friends for the first time, if this step was skipped during registration, or to further add to in network community. As illustrated in the example embodiment of FIG. 18, the My Friends GUI may be populated with users current community of iFlipd friends. Various tabs (e.g., 1802, 1804, 1806, 1810, 1814) may be provided for enabling the user to access various types of information and/or features such as, for example: friends, reviews, view library, transaction/activity history, settings, account information/profile, etc. GUI 1800 may also display the user's current value of accumulated Flip Days 1812.

Other features and/or functionality which may be accessed via the My Friends GUI may include, but are not limited to, one or more of the following (or combinations thereof):
Unique iFlipd community of friends from Facebook and Twitter allows users to see what friends are reading and what they think about the books they have read.
By browing friends books, a users may select a book and go directly to the Detail page to browse, rent, or buy the book.
Functionality for enabling a user to “follow” other users and also to see a friends “reading stats”.

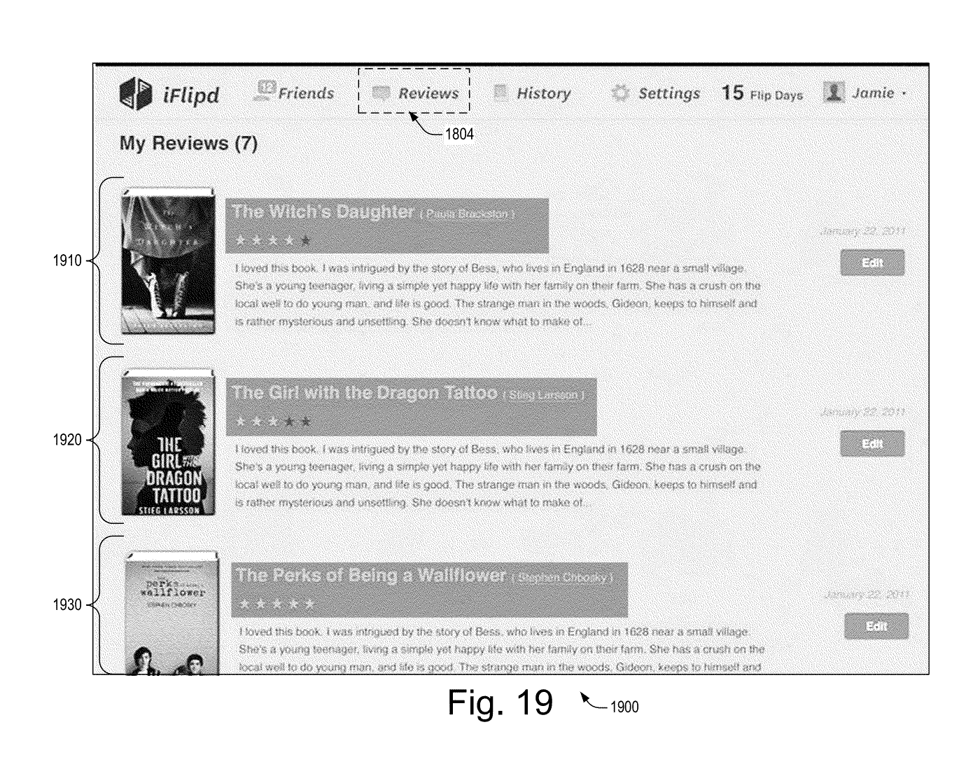

FIG. 19 illustrates an example screenshot of My Reviews GUI 1900 in accordance with a specific embodiment. As illustrated in the example GUI embodiment of FIG. 19, user may access a list (e.g., 1910, 1920, 1930) of their reviews displayed in reverse chronological order. If user did not rate the book when they reviewed it, “rating” stars are blank. User may add/edit their rating and review by taping “edit”. User taps “Authors Name” and is directed to search results page of the author's books.

Other features and/or functionality which may be accessed via the My Reviews GUI may include, but are not limited to, one or more of the following (or combinations thereof):
Manage reviews, ratings for one or more books read.
Users may edit reviews at a later time if desired.
Allows users to track their reading history and manage what they share to the outside community
Reviews may be directly shared on social networks.

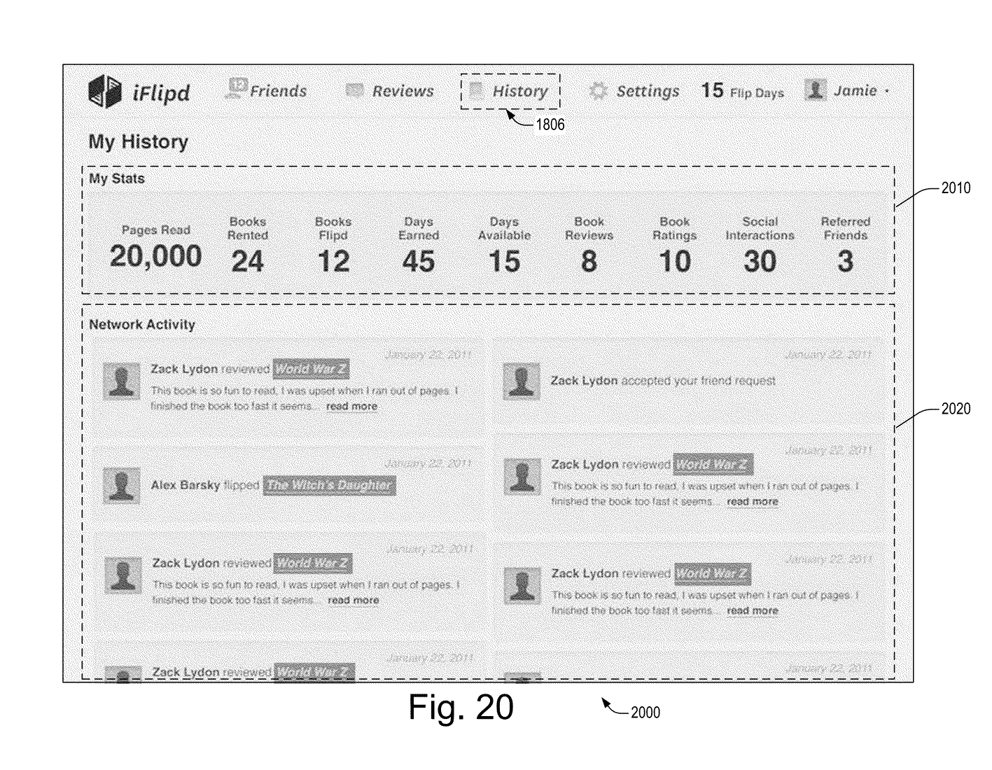

FIG. 20 illustrates an example screenshot of My History GUI 2000 in accordance with a specific embodiment. As illustrated in the example GUI embodiment of FIG. 20, user may review “My Stats” GUI portion 2010, which may be configured or designed as the user's personal dashboard of the user's historical in-network (and/or out-of-network) activities such as, for example, one or more of the following (or combinations thereof):
number of pages read;
number of books rented;
number of book Flipped;
total Flip Days earned;
current Flip Days available;
number of book reviews posted;
number of book ratings submitted;
number of social interactions;
number of referred friends;
etc.

In “Network Activity” section 2020, user may view the activities of other in-network users including, reviews, ratings, friend invitation accepted, book Flip activity, comments, etc.

Other features and/or functionality which may be accessed via the My History GUI may include, but are not limited to, one or more of the following (or combinations thereof):
iFlipd System keeps track of each users' individual stats and how they are reading.
Rewards are earned for reading behaviors such as number of books read, social interactions, friends referred, books Flipped, etc.
The network activity allows user to see at a glance what their friends are talking about in relation to iFlipd on a social network. Highlights book virality, exposure, and discoverability.

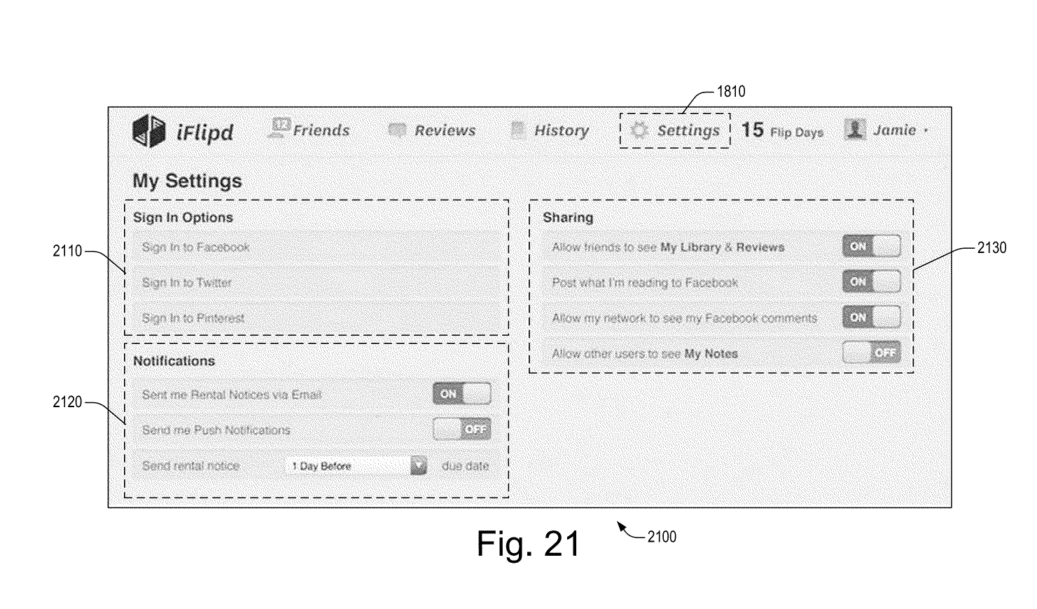

FIG. 21 illustrates an example screenshot of My Settings GUI 2100 in accordance with a specific embodiment. As illustrated in the example GUI embodiment of FIG. 21, user may access their settings. In “Sign In Options” GUI portion 2110, user may connect account to social media including Facebook, Twitter, and Pintrest. In “Notifications” GUI portion 2120, user may set when they would receive notice, 1 day before, 2 days before, or 3 days before their rental is set to renew. In “Sharing” GUI portion 2130, user may set what content of their in GUI application interactions is viewable by other iFlipd user.

Other features and/or functionality which may be accessed via the My Settings GUI may include, but are not limited to, one or more of the following (or combinations thereof):
Privacy settings allow users to be as social or private as they choose.
User may choose to be alerted for various site activity via push notifications or email.
Sign in directly and interact with social networks.

FIG. 22 illustrates an example screenshot of Account—Users GUI 2200 in accordance with a specific embodiment. As illustrated in the example GUI embodiment of FIG. 22, user may view, edit, and/or add users (e.g., 2202, 2204, 2206) to an account. Most accounts have one or more the privileges needed to manage a standard iFlipd user (passwords, credit cards, preferences). There may be more than one “Admin/Parent” user. “Child” users have more limited privileges are created via the check box in the “Add User” option.

Other features and/or functionality which may be accessed via the Account—Users GUI may include, but are not limited to, one or more of the following (or combinations thereof):
Admin user may add up to 10 accounts of either other adults or children.
COPPA compliance applies to children accounts.
New users may be asked for birthdays to confirm age.
At least one user may have a unique password and email to log into their account.
For multiple users of a given account, each user may be allowed to have unique libraries, recommendations, days, collections, stats, friends, etc.

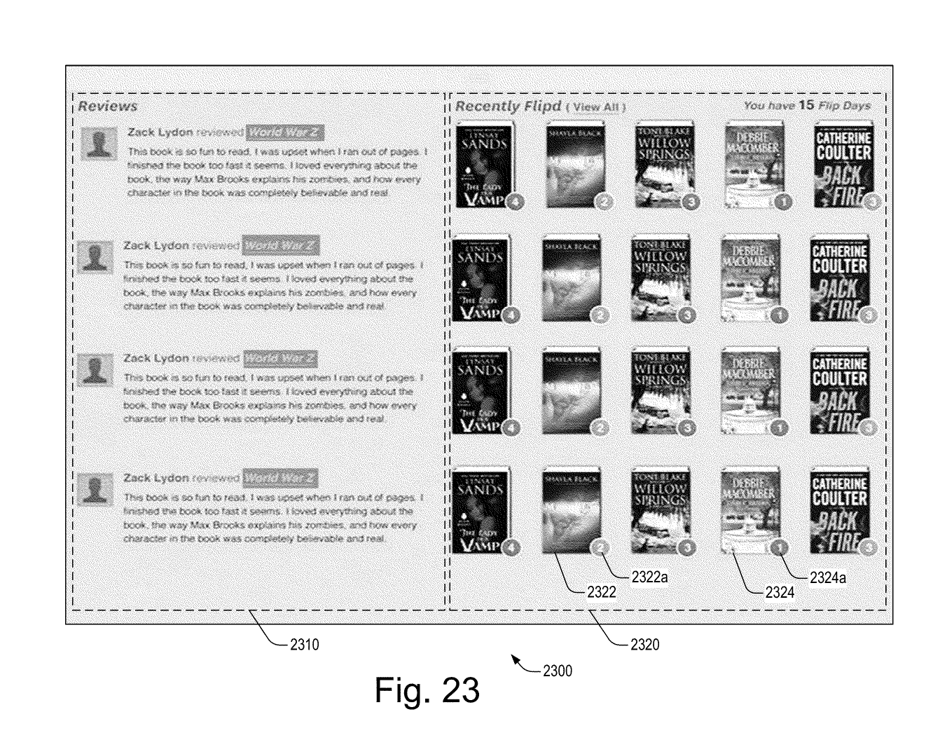

FIG. 23 illustrates an example screenshot of Bottom Menu GUI 2300 in accordance with a specific embodiment. As illustrated in the example GUI embodiment of FIG. 23, user may view various information relating to social updates 2310 and books 2320 that have been Flipped. Number badges (e.g., 2322a, 2324a) indicate remaining number of days for the associated book (e.g., 2322, 2324), and may be color coded to indicate in/out of network, and/or other information.

In one embodiment, when accessing a “Category” type GUI (e.g., Romance, Sci Fi, Fiction, Horror, etc.), user may view books Flipd within that particular category. The Bottom Menu GUI 2300 may be accessable via other GUIs, and may be displayed (at least partially) in one or more other GUIs (e.g., as shown at 1610 and 1620 of FIG. 16). In one embodiment, the Bottom Menu GUI is collapsed by default. User swipes up to reveal first row. User swipes up again to fill GUI with additional rows of at least one item. When collapsed, a transparent bar with visual lines indicates that the menu is available.

Other features and/or functionality which may be accessed via the Bottom Menu GUI may include, but are not limited to, one or more of the following (or combinations thereof):
Users may view one or more the available Flips at the same time and scroll and sort through them to find titles.
Users may browse reviews and commentary of other users to see what they are saying about books in the Flip Pool Library.

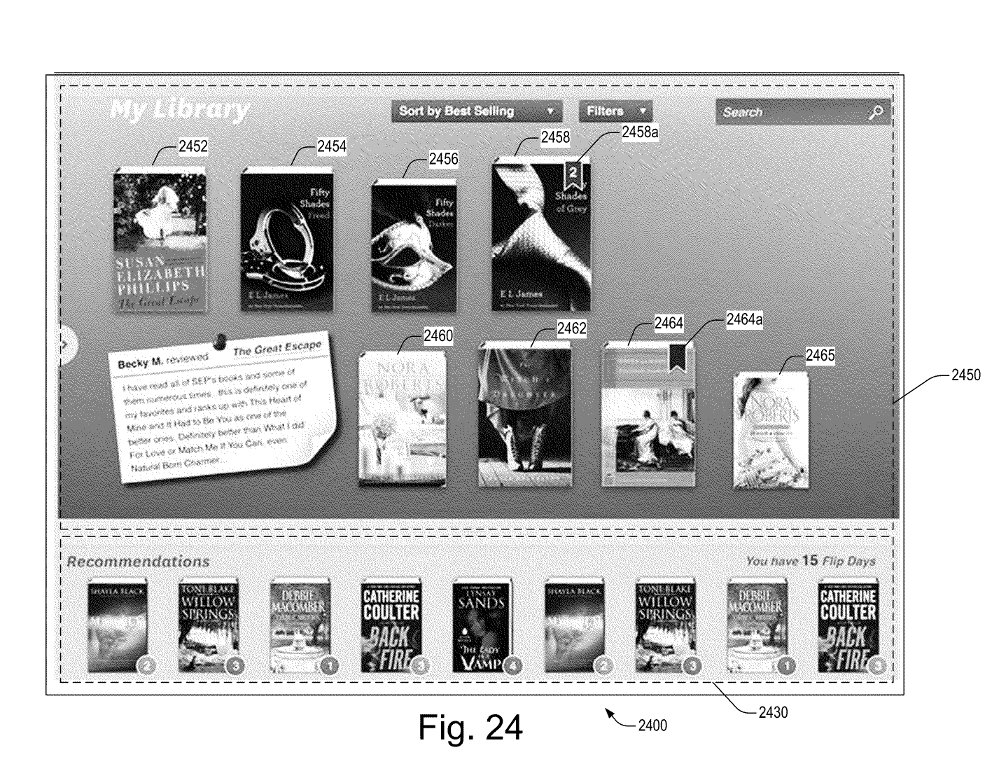

FIG. 24 illustrates an example screenshot of My Library GUI 2400 in accordance with a specific embodiment. In at least one embodiment, the My Library GUI 2400 may be configured or designed to function as, and to provide access to the user's Personal Library.

As illustrated in the example GUI embodiment of FIG. 24, user may view and access their books that have been purchased, rented, and/or added to the user's Personal Library. Rented books (e.g., 2458) may display a number badge (e.g., 2458a) indicating number of rental days remaining for that particular book. For previous rentals, book may appear greyed out. Other badges (e.g., 2464a) may be displayed to indicate that at least one copy of an identified book title (e.g., book title 2464) is available in the Flip Pool Library.

“Recommendations” GUI portion 2430 provides information relating to recommendations based upon reader's previous books.

Other features and/or functionality which may be accessed via the My Library GUI may include, but are not limited to, one or more of the following (or combinations thereof):
In some embodiments, separate personal libraries may be created for: books which the user is currently reading, books which the user owns, books which the user has previously rented, etc.
Individualized Flip recommendations based on reading behavior and interests.
When books are available in the library they are temporarily available if a reader is offline.
Books that are owned may not be made available to be Flipd out due to copyright regulation.
Badges indicate the time left with a book or a solid badge indicates owning a book.
Library may be sorted and searched for specific titles.

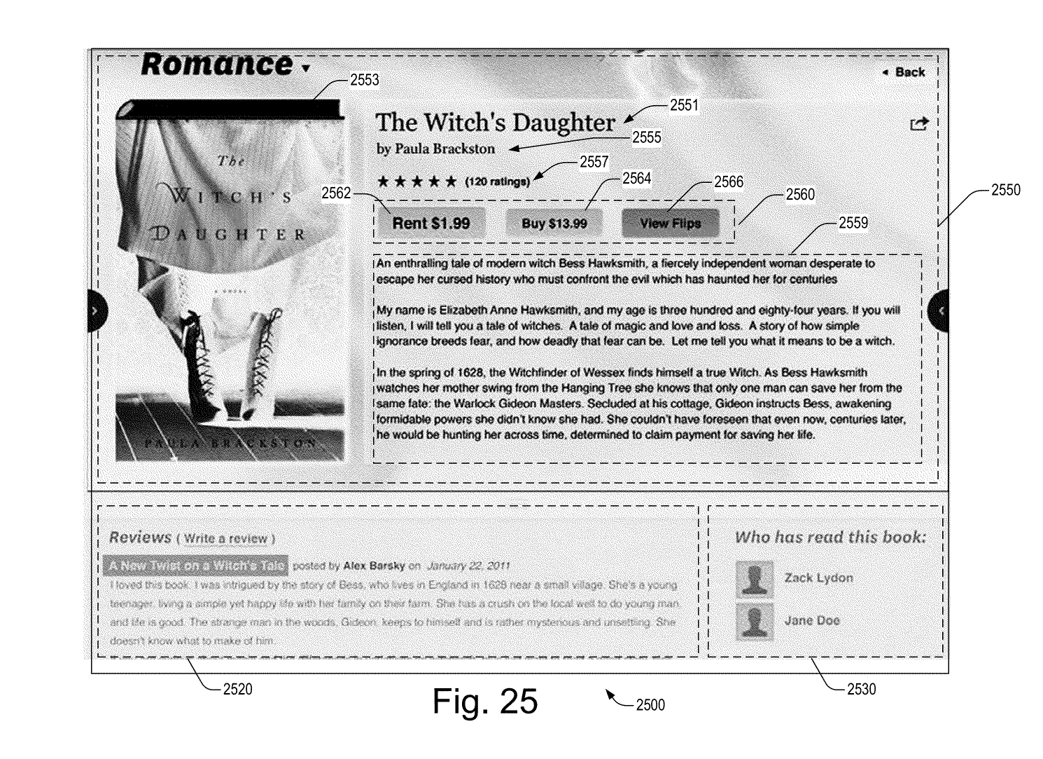

FIG. 25 illustrates an example screenshot of Book Detail GUI 2500 in accordance with a specific embodiment. As illustrated in the example GUI embodiment of FIG. 25, user may view various information relating to a book title such as, for example:
book title 2551;
author 2555;
book image 2553;
“new” rental price 2562;
“Flip” rental price;
Purchase price 2564;
ratings 2557;
description 2559;
reviews 2520;
those in network who have read the book 2530;

In one embodiment, the user may click on the View Flips icon 2566 to view other Flips of the book title which are available for rental/Check-Out from the Flip Pool Library.

User may write their own review by tapping “Write a review”. User may “rent” title for $1.99 per week. Book may be Flibbed into the Flip Pool Library before the end of the rental period, or user may be charged weekly up to maximum price of the book, at which time the user owns the title. User may “Buy” book for full price at anytime. During rental period, user may buy the title at a discount (purchase price less rental fees paid). Book returns to full price once the user returns the book to the system. If a user chooses to keep the book they may pay-as-you-go over time toward the purchase price and eventually own the book based on the prior payments.

Other features and/or functionality which may be accessed via the Book Detail GUI may include, but are not limited to, one or more of the following (or combinations thereof):
Metadata on the book is provided by publishers.
Users may link to other friends who have read the title.
Users may browse reviews at their fingertips or write their own review.
Pay-As-You-Go pricing allows user to buy a book over time.
Share button allows users to share any information and picture of the book on a social network and user is rewarded for this behavior.

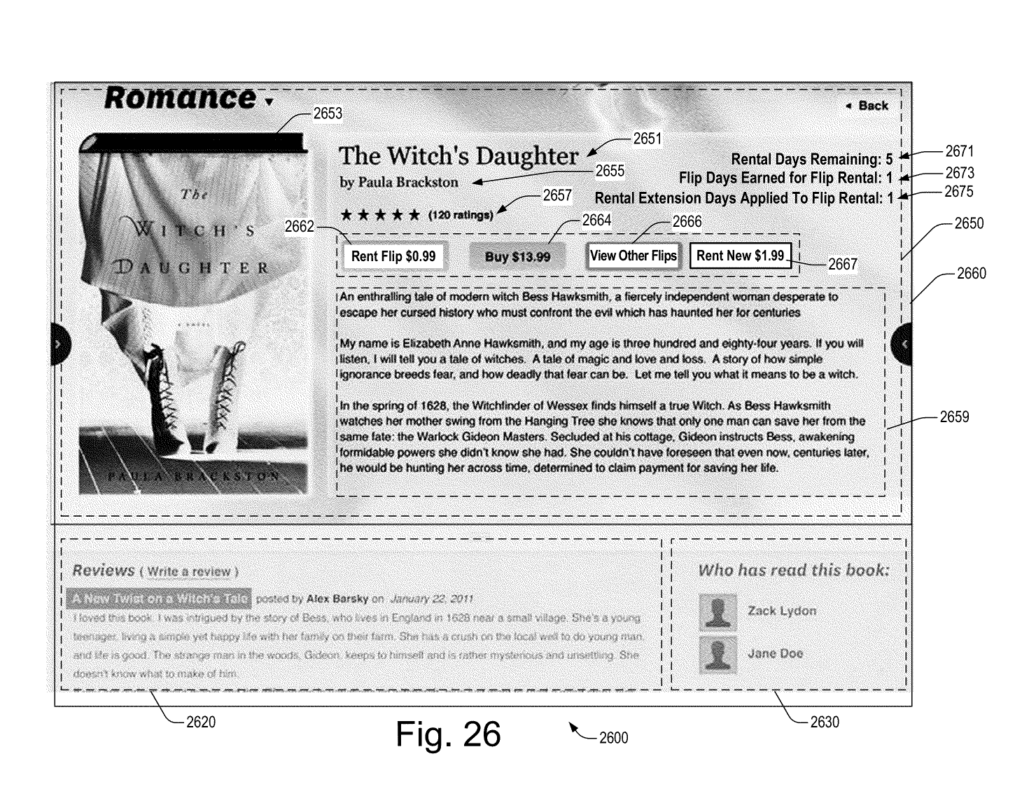

FIG. 26 illustrates an example screenshot of Flip Book Detail GUI 2600 in accordance with a specific embodiment. As illustrated in the example GUI embodiment of FIG. 26, user may view various information relating to a Flipped book title such as, for example:
book title 2651;
author 2655;
book image 2653;
“new” rental price 2667;
“Flip” rental price 2662;
Purchase price 2664;
ratings 2657;
description 2659;
reviews 2620;
those in network who have read the book 2630;
rental days remaining for the Flip book lease 2671;
number of Flip Days earned for renting Flip book 2673;
rental extension days to be applied to Flip rental 2675;
etc.

In one embodiment, the user may click on the View Flips icon 2666 to view other Flips of the book title which are available for rental/Check-Out from the Flip Pool Library.

As illustrated in the example embodiment of FIG. 26, user may “rent” title for $0.99 for a 5 day rental period. Book may be Flipped back into Flip Pool Library before end of the lease term or user may be charged weekly up to maximum price of the book, at which time the user owns the title. User may “Buy” book for full price at anytime. During rental period, user may buy the title at a discount (e.g., purchase price less rental fees paid). Book returns to full price once the user returns the book to the system. If a user chooses to keep the book they may pay-as-you-go over time toward the purchase price and eventually own the book based on the prior payments.

Other features and/or functionality which may be accessed via the Flip Book Detail GUI may include, but are not limited to, one or more those described and/or referenced herein.

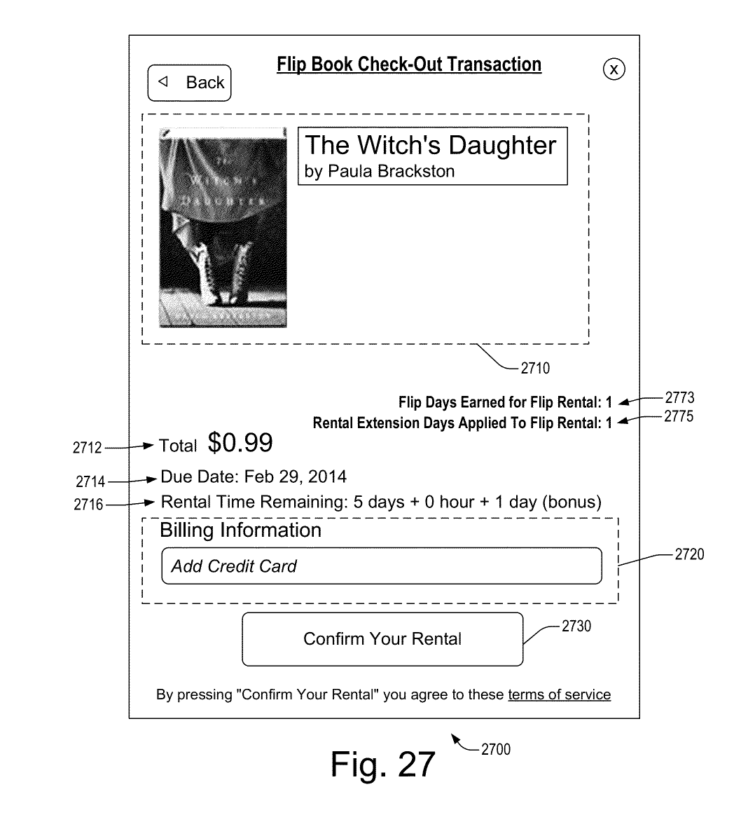

FIG. 27 illustrates an example screenshot of Flip Book Rental GUI 2700 in accordance with a specific embodiment. In the example GUI embodiment of FIG. 27, it is assumed user has tapped the “Rent Flip” button 2662 of the Flip Book Detail GUI (FIG. 26) to initiate a Flip Book Check-Out transaction for the identified Flip book title 2710.

As illustrated in the example embodiment of FIG. 27, the Flip Book Rental GUI 2700 may be configured or designed to display various information such as, for example, one or more of the following (or combinations thereof):
Total rental fee 2712 to be paid (e.g., $0.99).
Number of Flip Days earned for renting the Flip book 2773;
Number of rental extension days to be applied to Flip rental 2775.
Rental days remaining on the Flip book lease 2716.

In one embodiment, the rental “Due Date” or lease expiration date 2714 may be dynamically calculated (e.g., by the DME/L Server System) at time of the rental transaction and displayed. The amount of rental time remaining 2716 on the leased book may also be dynamically calculated at time of rental transaction and displayed. In this particular example, it is assumed that the DME/L Server System awards the user with an extra rental day (e.g., as shown at 2775) as bonus or reward for renting the Flip book.

In one embodiment, when the term of the Flip book lease expires, the user may no longer have access to the book, and the user is not charged any additional amounts. In other embodiments, if the leased book is not returned to the Flip Pool Library before the expiration of the Flip book lease, the rental may auto renew, and the user may be charged weekly or periodic “new rental” fee, up to maximum price of the book, at which time the user then owns the title.

If there is no credit card on file, the user may tap the Add Credit Card field whereupon a GUI may be presented for enabling the user to add a credit card to the user's account.

In some embodiments, such as that illustrated in the DME/L State Diagram of FIG. 10, the user may be requested to enter a predetermined PIN code in order enable the DME/L Server System to authenticate the user and complete the rental transaction.

Other features and/or functionality which may be accessed via the Flip Book Rental GUI may include, but are not limited to, one or more of the following (or combinations thereof):
In-application purchasing allows a seamless user experience.
Credit cards are managed through iTunes, iOS and/or Android platforms.
Easy and fast user experience.

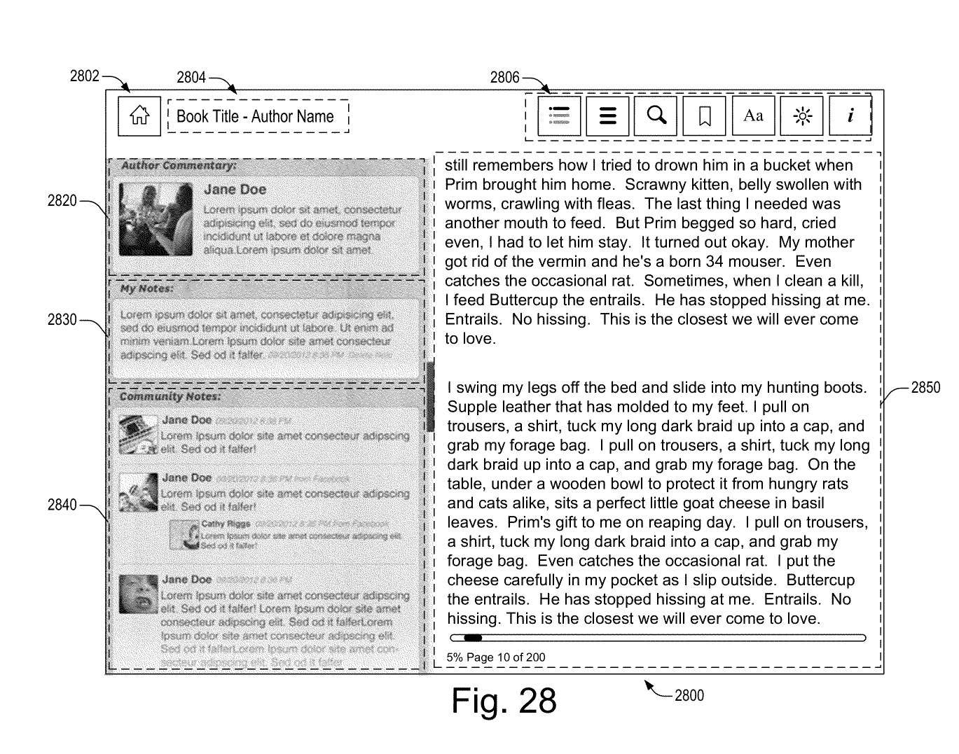

FIG. 28 illustrates an example screenshot of Reader GUI 2800 in accordance with a specific embodiment. As illustrated in the example GUI embodiment of FIG. 28, user may read purchased or rented Digital Media Products. The book content may be displayed via GUI portion 2850. The bottom of GUI portion 2850 indicates page number & percentage completed. A slider bar allows user to quickly access one or more parts of the book.

GUI portion 2806 may provide the user with access to various reader options/preferences such as, for example: text size, screen brightness, text searching capability, bookmarking, author/book-related information, notes, highlighting tools, definitions, view chapters, social network sharing, etc.

Various portions of the Reader GUI 2800 may display information and/or content relating to: “Author Commentary” 2820, “My Notes” 2830, “Community Notes” 2840, etc. These GUI portions may be configured or designed to enable the user to interact with other users.

In one embodiment, when user completes the book, the user may be presented with options to Flip, Review, Share, etc.

In some embodiments, one or more types of data and/or user reading behaviors may be tracked by the DME/L Application and/or DME/L Server System, and shared with publishers, authors and/or users.

Other features and/or functionality which may be accessed via the Reader GUI may include, but are not limited to, one or more of the following (or combinations thereof):
Unique conversation panel allows for publishers to upsell and affiliate market to readers and see what readers are saying.
Authors may interact and post in the page of the book and answer questions or share with readers and see what they are saying.
Users may post a comment or note and have a discussion thread page by page of the book, they may also share those notes or thoughts on social media and see what others are saying.
Users may keep private or public notes.
Brings social media into the pages of the book and brings the conversation into the reading experience.

Although several example embodiments of one or more aspects and/or features have been described in detail herein with reference to the accompanying drawings, it is to be understood that aspects and/or features are not limited to these precise embodiments, and that various changes and modifications may be effected therein by one skilled in the art without departing from the scope of spirit of the invention(s) as defined, for example, in the appended claims.

It is claimed:

1. A computer implemented method for facilitating electronic commerce via a computer network, the method comprising causing at least one processor to execute a plurality of instructions for:
providing a first user with electronic access to a first digital media library, the first digital media library including a first set of digital media products;
receiving a first rental request to lease or rent a first digital media product (“first DMP”) to a first user, the first DMP including a first portion of media content;
determining a first lease term associated with the first DMP;
initiating, in response to the first rental request, a first digital media product (DMP) lease purchase transaction for leasing the first DMP to the first user for a first rental period as defined by the first lease term;
receiving a first lease fee payment in connection with the first DMP lease purchase transaction;
generating access rights for enabling user access to access the first DMP and its media content during the first rental period;
granting, in response to completing the first DMP lease purchase transaction, the first user with access rights for enabling the first user to access the first DMP and its media content during the first rental period;
receiving a first Flip request to initiate a first Flip transaction to Flip the first DMP into a Flip Pool Library;
if it is determined that the first rental period has not expired, initiating, in response to the first Flip request, the first Flip transaction to Flip the first DMP into the Flip Pool Library;
rescinding, in response to completing the first Flip transaction, the first user's access rights to access the first DMP and its media content during the first rental period; and
enabling, in response to completing the first Flip transaction, other users to lease the first DMP from the Flip Pool Library before an expiration of the first rental period.

2. The computer implemented method of claim 1 further comprising causing the at least one processor to execute additional instructions for:
granting, in response to completing the first Flip transaction, the first user a reward or bonus.

3. The computer implemented method of claim 1 further comprising causing the at least one processor to execute additional instructions for:
granting the first user with at least one Flip Day reward in response to completing the first Flip transaction.

4. The computer implemented method of claim 1 further comprising causing the at least one processor to execute additional instructions for:
allocating portion of the first lease fee payment to a content creator or content provider of the first DMP.

5. The computer implemented method of claim 1 further comprising causing the at least one processor to execute additional instructions for:
dynamically determining a first amount of Flip Day(s) to be awarded to the first user upon completion of the first Flip transaction; and
granting the first user with the first amount of Flip Day(s) in response to completing the first Flip transaction.

6. The computer implemented method of claim 1 further comprising causing the at least one processor to execute additional instructions for:
determining a current amount of remaining rental time of the first rental period associated with the first DMP; and
dynamically determining, using the current amount of remaining rental time, a Flipped rental fee for renting or leasing the first DMP from the Flip Pool Library.

7. The computer implemented method of claim 1 further comprising causing the at least one processor to execute additional instructions for:
receiving a second rental request to lease or rent the first DMP from the Flip Pool Library to a second user;
initiating, in response to the second rental request, a Flipped DMP leasing transaction for leasing the first DMP from the Flip Pool Library to the second user;
receiving a Flipped rental fee payment in connection with the Flipped DMP leasing transaction;
granting, in response to completing the Flipped DMP leasing transaction, the second user with access rights for enabling the second user to access the first DMP and its media content while the first rental period has not yet expired; and
allocating portion of the Flipped rental fee payment to a content creator or content provider of the first DMP.

8. The computer implemented method of claim 1 further comprising causing the at least one processor to execute additional instructions for:
receiving a second rental request to lease or rent the first DMP from the Flip Pool Library to a second user;
determining an amount of remaining rental time of the first rental period associated with the first DMP;
dynamically determining, using the amount of remaining rental time, a Flipped rental fee for renting or leasing the first DMP from the Flip Pool Library;
initiating, in response to the second rental request, a Flipped DMP leasing transaction for leasing the first DMP from the Flip Pool Library to the second user;
receiving the Flipped rental fee payment in connection with the Flipped DMP leasing transaction;
granting, in response to completing the Flipped DMP leasing transaction, the second user with access rights for enabling the second user to access the first DMP and its media content while the first rental period has not yet expired; and
allocating portion of the Flipped rental fee payment to a content creator or content provider of the first DMP.

9. The computer implemented method of claim 1 further comprising causing the at least one processor to execute additional instructions for:
receiving a second rental request to lease or rent the first DMP from the Flip Pool Library to a second user;
initiating, in response to the second rental request, a Flipped DMP leasing transaction for leasing the first DMP from the Flip Pool Library to the second user;
providing an opportunity for the second user to extend the rental period associated with first DMP;
extending the rental period associated with first DMP by a specified amount of time in response to received input from the second user;
receiving a Flipped rental fee payment in connection with the Flipped DMP leasing transaction;
granting, in response to completing the Flipped DMP leasing transaction, the second user with access rights for enabling the second user to access the first DMP and its media content while the extended rental period has not yet expired.

10. The computer implemented method of claim 1 further comprising causing the at least one processor to execute additional instructions for:
receiving a second rental request to lease or rent the first DMP from the Flip Pool Library to a second user;
initiating, in response to the second rental request, a Flipped DMP leasing transaction for leasing the first DMP from the Flip Pool Library to the second user;
granting, in response to completing the Flipped DMP leasing transaction, the second user with access rights for enabling the second user to access the first DMP and its media content while the first rental period has not yet expired; and
preventing, in response to completing the Flipped DMP leasing transaction, other users from renting or leasing the first DMP from the Flip Pool Library while the second user has access rights for enabling the second user to access the first DMP and its media content.

11. A computer implemented system for facilitating electronic commerce via a computer network, the system comprising at least one processor operable to execute a plurality of instructions for:
receiving a first rental request to lease or rent a first digital media product (“first DMP”) to a first user, the first DMP including a first portion of media content;
determining a first lease term associated with the first DMP;
initiating, in response to the first rental request, a first digital media product (DMP) lease purchase transaction for leasing the first DMP to the first user for a first rental period as defined by the first lease term;
receiving a first lease fee payment in connection with the first DMP lease purchase transaction;
generating access rights for enabling user access to access the first DMP and its media content during the first rental period;
granting, in response to completing the first DMP lease purchase transaction, the first user with access rights for enabling the first user to access the first DMP and its media content during the first rental period;
receiving a first Flip request to initiate a first Flip transaction to Flip the first DMP into a Flip Pool Library;
if it is determined that the first rental period has not expired, initiating, in response to the first Flip request, the first Flip transaction to Flip the first DMP into the Flip Pool Library;
rescinding, in response to completing the first Flip transaction, the first user's access rights to access the first DMP and its media content during the first rental period; and
enabling, in response to completing the first Flip transaction, other users to lease the first DMP from the Flip Pool Library before an expiration of the first rental period.

12. The computer implemented system of claim 11 being further operable to cause the at least one processor to execute additional instructions for:
granting, in response to completing the first Flip transaction, the first user a reward or bonus.

13. The computer implemented system of claim 11 being further operable to cause the at least one processor to execute additional instructions for:
granting the first user with at least one Flip Day reward in response to completing the first Flip transaction.

14. The computer implemented system of claim 11 being further operable to cause the at least one processor to execute additional instructions for:
allocating portion of the first lease fee payment to a content creator or content provider of the first DMP.

15. The computer implemented system of claim 11 being further operable to cause the at least one processor to execute additional instructions for:
dynamically determining a first amount of Flip Day(s) to be awarded to the first user upon completion of the first Flip transaction; and
granting the first user with the first amount of Flip Day(s) in response to completing the first Flip transaction.

16. The computer implemented system of claim 11 being further operable to cause the at least one processor to execute additional instructions for:
determining a current amount of remaining rental time of the first rental period associated with the first DMP; and
dynamically determining, using the current amount of remaining rental time, a Flipped rental fee for renting or leasing the first DMP from the Flip Pool Library.

17. The computer implemented system of claim 11 being further operable to cause the at least one processor to execute additional instructions for:
receiving a second rental request to lease or rent the first DMP from the Flip Pool Library to a second user;
initiating, in response to the second rental request, a Flipped DMP leasing transaction for leasing the first DMP from the Flip Pool Library to the second user;
receiving a Flipped rental fee payment in connection with the Flipped DMP leasing transaction;
granting, in response to completing the Flipped DMP leasing transaction, the second user with access rights for enabling the second user to access the first DMP and its media content while the first rental period has not yet expired; and
allocating portion of the Flipped rental fee payment to a content creator or content provider of the first DMP.

18. The computer implemented system of claim 11 being further operable to cause the at least one processor to execute additional instructions for:
receiving a second rental request to lease or rent the first DMP from the Flip Pool Library to a second user;
determining an amount of remaining rental time of the first rental period associated with the first DMP;
dynamically determining, using the amount of remaining rental time, a Flipped rental fee for renting or leasing the first DMP from the Flip Pool Library;
initiating, in response to the second rental request, a Flipped DMP leasing transaction for leasing the first DMP from the Flip Pool Library to the second user;
receiving the Flipped rental fee payment in connection with the Flipped DMP leasing transaction;
granting, in response to completing the Flipped DMP leasing transaction, the second user with access rights for enabling the second user to access the first DMP and its media content while the first rental period has not yet expired; and
allocating portion of the Flipped rental fee payment to a content creator or content provider of the first DMP.

19. The computer implemented system of claim 11 being further operable to cause the at least one processor to execute additional instructions for:
receiving a second rental request to lease or rent the first DMP from the Flip Pool Library to a second user;
initiating, in response to the second rental request, a Flipped DMP leasing transaction for leasing the first DMP from the Flip Pool Library to the second user;
providing an opportunity for the second user to extend the rental period associated with first DMP;
extending the rental period associated with first DMP by a specified amount of time in response to received input from the second user;
receiving a Flipped rental fee payment in connection with the Flipped DMP leasing transaction;
granting, in response to completing the Flipped DMP leasing transaction, the second user with access rights for enabling the second user to access the first DMP and its media content while the extended rental period has not yet expired.

20. The computer implemented system of claim 11 being further operable to cause the at least one processor to execute additional instructions for:
receiving a second rental request to lease or rent the first DMP from the Flip Pool Library to a second user;
initiating, in response to the second rental request, a Flipped DMP leasing transaction for leasing the first DMP from the Flip Pool Library to the second user;
granting, in response to completing the Flipped DMP leasing transaction, the second user with access rights for enabling the second user to access the first DMP and its media content while the first rental period has not yet expired; and
preventing, in response to completing the Flipped DMP leasing transaction, other users from renting or leasing the first DMP from the Flip Pool Library while the second user has access rights for enabling the second user to access the first DMP and its media content.
